(19) United States
(12) Patent Application Publication
(10) Pub. No.: US 2017/0204942 A1
(43) Pub. Date: Jul. 20, 2017

(54) MULTI-SPEED TRANSMISSION FOR RAIL VEHICLES

(71) Applicant: ZF Friedrichshafen AG, Friedrichshafen (DE)

(72) Inventors: Kazutaka IUCHI, Markdorf (DE); Michael WECHS, Weißensberg (DE); Stefan BECK, Eriskirch (DE); Viktor WARTH, Friedrichshafen (DE); Bernd SOMSCHOR, Tettnang (DE); Benedikt REICK, Friedrichshafen (DE)

(73) Assignee: ZF Friedrichshafen AG, Friedrichshafen (DE)

(21) Appl. No.: 15/323,464

(22) PCT Filed: Jun. 2, 2015
(86) PCT No.: PCT/EP2015/062246

§ 371 Date: Mar. 31, 2017

(30) Foreign Application Priority Data
Jul. 4, 2014 (DE) 102014213012.3

(51) Int. Cl. F16H 3/66; B61C 9/00; F16H 3/54

(52) U.S. Cl. CPC F16H 3/66; F16H 3/54; B61C 9/00; F16H 2200/2097; F16H 2200/0034; F16H 2200/0039; F16H 2200/2005; F16H 2200/2007; F16H 2200/2033; F16H 2200/2035; F16H 2200/2064; F16H 2200/2094

(57) ABSTRACT

A multi-speed transmission (9) for a rail vehicle. The multi-speed transmission (9) has at least one transmission input (AN), at least one transmission output (AB), at least one planetary gearset (PR1, PR2), at least one shifting element (SE1, SE2) and a housing (G). The planetary gearset (PR1, PR2) has a sun gear (S1, S2), at least one planetary carrier (PT1, PT2) with planetary gearwheels, and a ring gear (H1, H2), and rotational movement from a drive element (8) is introduced into the multi-speed transmission (9). By actuating the at least one shifting element (SE1, SE2), at least two different transmission ratios can be obtained between the transmission input (AN) and the transmission output (AB).

This application is a National Stage completion of PCT/EP2015/062246 filed Jun. 2, 2015, which claims priority from German patent application serial no. 10 2014 213 012.3 filed Jul. 4, 2014.

### FIELD OF THE INVENTION

The invention concerns a shiftable multi-speed transmission for rail vehicles, in particular electric multiple-unit trains, the so-termed Electrical Multiple Units (EMUs).

### BACKGROUND OF THE INVENTION

Rail vehicles are distinguished by the fact that they run or are guided on one or more rails. Besides the above-mentioned multiple-unit trains, locomotives too should be mentioned in this context. A multiple-unit train is as a rule understood to be a non-separable unit consisting of a plurality of vehicles/train segments such that the multiple-unit train has a drive unit of its own. In this context one vehicle/train segment, more than one vehicle/train segment or all the vehicles/train segments of the multiple-unit train can each have a drive unit. Besides electrical multiple-unit trains (EMUs) there are also, for example, diesel-powered multiple-unit trains, the so-termed Diesel Multiple Units (DMUs). These comprise one or more diesel engines specific to their vehicles instead of the electric motors in electrical multiple-unit trains (EMUs).

DE 1177671B discloses a drive control system for rail multiple-unit trains, in particular for bogie locomotives. In this case the rail multiple-unit train vehicles have at least one reversible electric drive motor, which is in each case functionally connected to an interlocking transmission. In particular, an electric drive motor with an interlocking transmission is arranged on each bogie of the rail multiple-unit train. By means of a gear selector in the switchgear one of two possible gears (first gear, second gear) is preselected. By means of a shifting unit and a final control device a piston rod is actuated in such manner that by means of a shifting fork connected to the piston rod, a rotationally fixed connection with the desired transmission ratio is formed between the electric drive motor and the drive output. The interlocking transmissions have in each case two gearwheel pairs that engage with one another. In these the loose wheels are arranged on the drive input shaft and the fixed wheels on the drive output shaft, with the drive input shaft positioned over the drive output shaft.

### SUMMARY OF THE INVENTION

The purpose of the present invention is to propose a multi-speed transmission particularly for rail vehicles, with which the drive-train of the rail vehicle can work with greater efficiency, wherein the multi-speed transmission in particular has high efficiency at the same time as small dimensions.

According to the invention, this objective is achieved by a multi-speed transmission as described below. The multi-speed transmission comprises in this case at least one transmission input and a transmission output, as well as at least one planetary gearset, a shifting element and a housing.

A planetary transmission or planetary gearset comprises as a rule at least one sun gear, a planetary carrier and a ring gear. Mounted to rotate on the planetary carrier are planetary gearwheels, which mesh with the teeth of the sun gear and/or with the teeth of the ring gear.

In this case the at least one planetary gearset comprises at least one sun gear, one or more planetary gearwheels, a planetary carrier and a ring gear.

Planetary gearsets can basically be either minus-planetary gearsets or plus-planetary gearsets. A minus-planetary gearset preferably describes a single-planetary gearset with a planetary carrier on which the planetary gearwheels are mounted to rotate, with a sun gear and a ring gear, wherein the teeth of at least one of the planetary gearwheels mesh with the teeth of both the sun gear and the ring gear, so that the ring gear and the sun gear rotate in opposite rotational directions when the sun gear is rotating and the planetary carrier is fixed. A plus-planetary gearset preferably differs from the minus-planetary gearset just described in that the plus-planetary gearset has inner and outer planetary gearwheels mounted to rotate on it. The teeth of the inner planetary gearwheels mesh on one side with the teeth of the sun gear and on the other side with the teeth of the outer planetary gearwheels. The teeth of the outer planetary gearwheels also mesh with the teeth of the ring gear. The result is that when the planetary carrier is fixed, the ring gear and the sun gear rotate in the same direction.

The use of planetary gearsets enables particularly compact multi-speed transmissions to be made, so that there is great freedom of choice for the arrangement of the multi-speed transmission in the rail vehicle. The elements of a planetary gearset are understood to be, in particular, the sun gear, the ring gear, the planetary carrier and the planetary gearwheels of the planetary gearset.

Further preferable features are that rotational movement can be transmitted from a drive input element into the multi-speed transmission, and that by actuating the at least one shifting element, at least two different transmission ratios between the transmission input and the transmission output can be obtained.

A multi-speed transmission is preferably distinguished by the fact that rotational speed or torque is transmitted from a transmission input to a transmission output in accordance with different transmission ratios. The transmission input is preferably located on one side of the transmission facing toward a drive element such as an internal combustion engine or an electric motor. The transmission output is preferably on a side of the transmission opposite from the transmission input, for example arranged coaxially with the transmission input or else in a parallel but offset arrangement. However, versions are also conceivable in which the transmission input and the transmission output are arranged on the same side of the multi-speed transmission.

In this context a transmission input describes a point on a multi-speed transmission at which rotational movement, for example from a drive element, is introduced into the multi-speed transmission. In contrast, a transmission output is a point in the multi-speed transmission from which, having regard to the transmission ratio at the time, the rotational movement introduced at the transmission input passes out of the multi-speed transmission. In a multi-speed transmission a plurality of gears, but at least two gears, i.e. different transmission ratios, can be engaged.

In the case of shifting elements one distinguishes basically between brakes and clutches. A brake is understood to be a shifting element connected on one side to a fixed element such as a housing, and on another side to a rotatable element such as a shaft or a gearwheel. In what follows, a brake that has not been actuated is understood to be an open brake. This means that the rotatable element is able to rotate freely, i.e. the brake preferably has no influence on the rotational speed of the rotatable element. When the brake is actuated or closed, the rotary movement of the rotatable element is reduced, for example stopped, i.e. a rotationally fixed connection can be formed between the rotatable element and the fixed element.

By means of a brake, a preferably interlocked or frictional rotationally fixed connection can be formed or separated. As a rule, a frictional connection between two elements means that by means of an actuator a force is applied at the connection point, which produces a frictional force by virtue of which force or torque can be transferred between the rotatable element and the fixed element such that a fixed connection is formed. The actuator can be actuated by an electric motor, or pneumatically, or electro-hydraulically, or electromagnetically, or in some other way.

In interlocking connections, a connection is formed by virtue of an interlock between the contours of the two elements. Interlocking connections have the particular advantage that they can transmit high forces and torques while being comparatively small and light. Furthermore the energy to be provided when forming the connection is substantially less than with frictional connections, so that for example the actuator can also be made smaller.

In this connection “brakeable” is understood to mean that by actuating the brake, a rotational speed difference between the two elements can be reduced and the rotatable element can be brought to rest. Thus, by actuating a frictional brake a transition can be made from rotational movement of the rotatable element, through a reduction of its rotation, down to rest. Conversely, rotational movement can be increased step by step, for example from when the rotatable element is at rest. With an interlocking brake the only two conditions possible for the rotatable element are those of being at rest, or rotating freely.

On the other hand, clutches are shifting elements which, depending on their state of actuation, allow a relative movement between two elements or form a connection for the transfer of a torque or a force. A relative movement is understood to mean for example that the two elements are rotating with different rotation speeds from one another. Furthermore, it is conceivable that only one of the two elements is rotating while the other is at rest, or is rotating in the opposite direction.

In what follows, a clutch that has not been actuated is understood to be an open clutch. This means that relative movement between the two elements is possible. When the clutch has been actuated or is closed, the two elements accordingly rotate at the same rotational speed in the same rotational direction. Analogously to the above-described designs of brakes, clutches too can be designed as frictional or interlocking shifting elements.

It is, further, to be preferred that at least one shifting element is made as a dual shifting element. A dual shifting element is distinguished for example in that by means of it a first rotatable element can be connected to a second rotatable element or the second rotatable element can be connected to a third rotatable element, whereas the dual shifting element comprises only a single actuator. Alternatively, in addition to the shift conditions just mentioned the dual shifting element can have still another shift condition, namely a neutral position. This means that no connection is formed either between the first and second elements or between the second and third elements. The use of dual shifting elements enables particularly compact shifting element arrangements to be produced. Moreover the number of components needed is reduced, since for the various shift conditions only one actuator in total is required.

In a preferred design form the multi-speed transmission comprises a first planetary gearset and a second planetary gearset. Preferably also, at the transmission input rotational movement can be introduced into the multi-speed transmission by way of a drive input shaft. In particular, a drive input shaft is understood to be a shaft preferably arranged at the transmission input. Advantageously, by way of the shaft rotational movement, for example from a drive element, can be introduced into the multi-speed transmission.

In what follows, a shaft is understood to mean not exclusively a—for example—cylindrical machine element mounted to rotate so as to transmit torques, but rather, the term includes connecting elements in general that connect individual components or elements to one another, in particular connecting elements which connect a plurality of elements to one another in a rotationally fixed manner. Further, a shaft denotes a mechanical element with a defined rigidity by means of which, preferably, torques or rotational movements can be transmitted between two or more components connected to the shaft. Depending on the design, however, translational movements, i.e. movements brought about by tension or pressure forces, for example along a rotational axis, can also be transmitted.

Furthermore, instead of being connected via a shaft or some other connecting element, two elements can also be connected to one another directly by a weld joint, a screw joint, by adhesive bonding, by clamping or by a plug-in connection. Alternatively, it is also conceivable that the two elements to be joined are made integrally, as one piece.

In particular, two elements are said to be joined to one another when a firm connection, in particular a rotationally fixed connection exists between the elements. In particular, elements connected in such manner rotate at the same speed in the same rotational direction. In what follows two elements are said to be connectable if a releasable rotationally fixed connection can be formed between the elements. In particular, when the connection exists such elements rotate at the same speed in the same direction.

Also preferably, the drive input shaft is connected to the sun gear of the first planetary gearset. The planetary carrier of the first planetary gearset is preferably connected, via a third shaft, to the ring gear of the second planetary gearset. The ring gear of the first planetary gearset is preferably connected by a fourth shaft to the shifting element, while a fifth shaft is also connected by the shifting element to the housing and the shifting element is connected by a drive output shaft to the planetary carrier of the second planetary gearset. By means of the shifting element, either the fifth shaft can be connected to the fourth shaft, or the drive output shaft can be connected to the fourth shaft. Also preferably, the sun gear of the second planetary gearset is connected by way of a sixth shaft to the housing. By virtue of the arrangement described, preferably two different transmission ratios, i.e. two different gears can be obtained between the transmission input and the transmission output. Particularly preferably, the stationary gear ratio of the first planetary gearset is i₀₁=−1.75 and the stationary gear ratio of the second planetary gearset is i₀₂=−1.750. The stationary gear ratio is the gear ratio between the sun gear and the ring gear when the planetary carrier is at rest. Also preferably, the first gear can be obtained when by means of the shifting element the fourth shaft is connected to the fifth shaft. The second gear can be obtained when by means of the shifting element the drive output shaft is connected to the fourth shaft. In this case the first gear preferably has a transmission ratio of i=4.322 and the second gear a transmission ratio of i=2.571. Consequently, the gear interval between the first and second gears is φ=1.681.

A drive output shaft is preferably understood to be a shaft arranged in particular in an area of the transmission output of the multi-speed transmission. Specifically, by way of the drive output shaft rotational movement produced by a drive element is passed on after being stepped up or down by the multi-speed transmission, for example so that a vehicle axle or a wheel is driven thereby.

In a further preferred embodiment of the multi-speed transmission, the transmission comprises a first planetary gearset and a second planetary gearset and at the transmission input rotational movement can be introduced into the multi-speed transmission by way of the drive input shaft. Preferably also, the drive input shaft is connected to the sun gear of the first planetary gearset. The transmission output is preferably connected via the drive output shaft to the planetary carrier of the first planetary gearset, and also preferably, the planetary carrier of the second planetary gearset is connected to the ring gear of the second planetary gearset by the drive output shaft. Preferably the ring gear of the first planetary gearset is connected, via a third shaft, to the shifting element, whereas by way of a fourth shaft the shifting element is connected to the housing and by way of a fifth shaft the shifting element is connected to the planetary carrier of the second planetary gearset. Preferably, by means of the shifting element either the fourth shaft can be connected to the third shaft, or the third shaft can be connected to the fifth shaft. Preferably also, the sun gear of the second planetary gearset is connected to the housing by means of a sixth shaft. Accordingly, in a preferred manner two different transmission ratios between the transmission input and the transmission output can be obtained. Particularly preferably, the stationary gear ratio of the first planetary gearset is i₀₁=−1.750 and the stationary transmission ratio of the second planetary gearset i₀₂=−1.750. The first gear can be obtained by connecting the fourth shaft by means of the shifting element to the third shaft. The second gear can be obtained by connecting the third shaft by means of the shifting element to the fifth shaft. The transmission ratio of the first gear is then i=2.750 and the transmission ratio of the second gear is i=1.636. The gear interval between the first and second gears is φ=1.681.

In a further preferred form of the design, the multi-speed transmission comprises a first planetary gearset and a second planetary gearset, and at the transmission input rotational movement can preferably be introduced into the multi-speed transmission by a drive input shaft. Also preferably, the drive input shaft is connected to the sun gear of the first planetary gearset and also to the sun gear of the second planetary gearset. Preferably also, the ring gear of the first planetary gearset is connected by way of a fourth shaft to the housing. The planetary carrier of the first planetary gearset is preferably connected by a third shaft to the shifting element, while the shifting element is connected by way of a fifth shaft to the ring gear of the second planetary gearset and by way of a sixth shaft the shifting element is connected to the housing. By means of the shifting element, preferably either the third shaft and the fifth shaft, or the fifth shaft and the sixth shaft can be connected to one another. The planetary carrier of the second planetary gearset is connected by a drive output shaft to the transmission output. Thus, preferably two different transmission ratios between the transmission input and the transmission output can be obtained. The stationary gear ratio of the first planetary gearset is in this case i₀₁=−2.577 and the stationary gear ratio of the second planetary gearset is i₀₂=−2.789. The first forward gear can be obtained when the shifting element connects the fifth and sixth shafts with one another. The transmission ratio of the first gear is i=3.577. The second gear is obtained when the shifting element connects the third shaft to the fifth shaft. The transmission ratio of the second gear is i=2.129. The gear interval between the first and second gears is φ=1.680.

In a further preferred embodiment, the multi-speed transmission has a first planetary gearset and a second planetary gearset, and at the transmission input, rotational movement can be introduced into the multi-speed transmission by a drive input shaft. Preferably, the drive input shaft is connected to the ring gear of the first planetary gearset. The planetary carrier of the first planetary gearset is preferably connected by way of a drive output shaft to the transmission output and, in addition, to the ring gear of the second planetary gearset. Preferably also, the sun gear of the first planetary gearset is connected by a fourth shaft to the shifting element, whereas by way of a fifth shaft the shifting element is connected to the sun gear of the second planetary gearset and, by a sixth shaft, the shifting element is connected to the housing. Preferably, by means of the shifting element either the fifth shaft can be connected to the fourth shaft or the fourth shaft can be connected to the sixth shaft. In that way two different transmission ratios between the transmission input and the transmission output can be obtained. Preferably, the stationary gear ratio of the first planetary gearset is i₀₁=−2.577 whereas the stationary gear ratio of the second planetary gearset is i₀₂=−2.789. The first gear has a transmission ratio of i=2.283 and the second gear a transmission ratio of i=1.359. This results in a gear interval of φ=1.680. The first gear can be obtained when the shifting element connects the fourth shaft to the fifth shaft. The second gear can be obtained when the fourth shaft is connected to the sixth shaft.

In another advantageous design version, the multi-speed transmission comprises a first shifting element and a second shifting element, and at the transmission input, rotational movement can be introduced into the multi-speed transmission by means of a drive input shaft. Preferably also, the drive input shaft is connected to the first shifting element and to the second shifting element as well, whereas by way of a third shaft, the first shifting element is advantageously connected to the ring gear of the first planetary gearset and by way of a fourth shaft, the first shifting element is connected to the housing. Preferably, by means of the first shifting element, either the drive input shaft can be connected to the third shaft or the third shaft can be connected to the fourth shaft. Also preferably, the second shifting element is connected by way of a fifth shaft to the sun gear of the planetary gearset and by way of a sixth shaft, the second shifting element is connected to the housing. Preferably, by means of the second shifting element, the fifth shaft can be connected either to the drive input shaft or to the sixth shaft. The planetary carrier of the planetary gearset is preferably connected by a drive output shaft to the transmission output. In this way, advantageously three different transmission ratios between the transmission input and the transmission output can be obtained. The stationary gear ratio of the planetary gearset is i₀₁=−1.620. The first gear can preferably be obtained when the first shifting element connects the drive input shaft to the third shaft and the second shifting element connects the fifth shaft to the sixth shaft. The transmission ratio of the first gear is preferably i=2.620. The second gear is preferably obtained when the first shifting element connects the third shaft to the fourth shaft and the second shifting element connects the drive input shaft to the fifth shaft. The transmission ratio of the second gear is preferably i=1.617. The gear interval between the first and second gears is preferably φ=1.620. The third gear is obtained when the first shifting element connects the drive input shaft to the third shaft and the second shifting element connects the drive input shaft to the fifth shaft. Advantageously, the transmission ratio of the third gear is i=1.0 so that the gear interval between the second and third gears is advantageously φ=1.617.

In a further preferred embodiment the multi-speed transmission has a first planetary gearset, a second planetary gearset, a first shifting element and a second shifting element. In this case, advantageously rotational movement can be introduced by way of a drive input shaft into the multi-speed transmission. Preferably also, the drive input shaft is connected to the first shifting element and also to the planetary carrier of the first planetary gearset. By way of a third shaft the first shifting element is preferably connected to the ring gear of the second planetary gearset and to the sun gear of the first planetary gearset. The shifting element is also connected by a fourth shaft to the housing, and by means of the first shifting element, particularly preferably, either the drive input shaft can be connected to the third shaft or the third shaft can be connected to the fourth shaft. Preferably, the ring gear of the first planetary gearset is connected by a fifth shaft to the second shifting element and also to the sun gear of the second planetary gearset. By way of a sixth shaft, the second shifting element is also connected to the housing, and by means of the second shifting element, the fifth shaft can be connected to the sixth shaft. Preferably, the planetary carrier of the second planetary gearset is connected by a drive output shaft to the transmission output. This gives three different transmission ratios between the transmission input and the transmission output. The stationary gear ratio of the first planetary gearset and of the second planetary gearset, at i₀₁=i₀₂=−2.0, are identical. Preferably also, the first gear can be obtained when the first shifting element connects the third shaft to the fourth shaft. The transmission ratio of the first gear is preferably i=2.0. The second gear can be obtained when the first shifting element connects the drive input shaft and the third shaft to one another. Preferably, the transmission ratio of the second gear is i=1.0. This gives a gear interval between the first and second gears of φ=2.0. The third gear can be obtained when the second shifting element connects the fifth shaft and the sixth shaft to one another. The transmission ratio of the third gear is preferably i=0.5, which means that the gear interval between the second gear and the third gear is φ=2.0.

In an also preferred design version the multi-speed transmission has a first planetary gearset, a second planetary gearset, a first shifting element and a second shifting element. At the transmission input, by way of the drive input shaft, rotational movement can preferably be introduced into the multi-speed transmission. The drive input shaft is preferably connected to the first shifting element and also to the sun gear of the first planetary gearset. Preferably also, the first shifting element is connected by a third shaft to the ring gear of the first planetary gearset and to the second shifting element as well. By way of a fourth shaft, the first shifting element is preferably connected to the housing, and by means of the first shifting element either the drive input shaft can be connected to the third shaft or the third shaft can be connected to the fourth shaft. Preferably, the planetary carrier of the first planetary gearset is connected, via a drive output shaft, to the ring gear of the second planetary gearset and also to the transmission output. Also preferably, the second shifting element is connected by a fifth shaft to the planetary carrier of the second planetary gearset, and by means of the second shifting element, the third shaft can be connected to the fifth shaft. Preferably, the sun gear of the second planetary gearset is connected by a sixth shaft to the housing. This gives three different transmission ratios between the transmission input and the transmission output. The stationary gear ratio of the first planetary gearset is preferably i₀₁=−2.0 and the stationary gear ratio of the second planetary gearset is i₀₂=−3.0. The first gear can preferably be obtained when the first shifting element connects the third shaft to the fourth shaft. The transmission ratio of the first gear is preferably i=4.0. The second gear can be obtained when the second shifting element connects the fifth shaft to the third shaft. The transmission ratio of the second gear is preferably i=2.0, so the gear interval between the first and second gears is preferably φ=2.0. The third gear is preferably obtained by means of the first shifting element, when the first shifting element connects the drive input shaft to the third shaft. The transmission ratio of the third gear is preferably i=1.0, so the gear interval between the second gear and the third gear is φ=2.0.

In another preferred embodiment the multi-speed transmission again has a first planetary gearset, a second planetary gearset, a first shifting element and a second shifting element, and at the transmission input rotational movement can be introduced into the multi-speed transmission by a drive input shaft. Preferably also, the drive input shaft is connected to the sun gear of the first planetary gearset, the sun gear of the second planetary gearset and the second shifting element. The planetary carrier of the second planetary gearset is preferably connected by a drive output shaft to the transmission output. Preferably also, the ring gear of the first planetary gearset is connected by a third shaft to the first shifting element and also to the planetary carrier of the second planetary gearset. Preferably, the first shifting element is also connected by way of a fourth shaft to the housing, so that by means of the first shifting element the third shaft can be connected to the fourth shaft. Preferably, the ring gear of the second planetary gearset is connected by a fifth shaft to the second shifting element and the second shifting element is connected by a sixth shaft to the housing. By means of the second shifting element, preferably either the fifth shaft can be connected to the sixth shaft or the fifth shaft can be connected to the drive input shaft. In this way three different transmission ratios between the transmission input and the transmission output can be obtained. The stationary gear ratio of the first planetary gearset is preferably i₀₁=−3.0 and the stationary gear ratio of the second planetary gearset is preferably i₀₂=−2.0. The first gear can preferably be obtained when the first shifting element connects the third shaft to the fourth shaft. The transmission ratio of the first gear is then preferably i=4.0. The second gear can preferably be obtained when the second shifting element connects the fifth shaft to the sixth shaft. The transmission ratio of the second gear is then i=2.0. This results in a gear interval of φ=2.0. The third gear is preferably obtained when the second shifting element connects the drive input shaft to the fifth shaft. The transmission ratio of the third gear is then i=1.0, which gives a gear interval between the second and third gears of φ=2.0.

In a further preferred embodiment the multi-speed transmission again has a first planetary gearset, a second planetary gearset, a first shifting element and a second shifting element, and at the transmission input rotational movement can be introduced into the multi-speed transmission by a drive input shaft. Preferably, the drive input shaft is connected to the first shifting element and also to the sun gear of the first planetary gearset and to the sun gear of the second planetary gearset as well. Preferably, the first shifting element is connected by a drive output shaft to the transmission output and also to the planetary carrier of the first planetary gearset. By means of the first shifting element the drive input shaft can preferably be connected to the drive output shaft. The ring gear of the first planetary gearset is preferably connected to the second shifting element by a third shaft. The second shifting element is further connected by a fourth shaft to the housing and by a fifth shaft preferably to the planetary carrier of the second planetary gearset. Preferably, by means of the second shifting element, either the fourth shaft can be connected to the third shaft or the third shaft can be connected to the fifth shaft. Preferably, the ring gear of the second planetary gearset is connected by a sixth shaft to the housing. In this way three different transmission ratios between the transmission input and the transmission output can be obtained. The stationary gear ratio of the first planetary gearset is i₀₁=−3.0 and the stationary gear ratio of the second planetary gearset is preferably i₀₂=−2.0. The first gear can preferably be obtained when the second shifting element connects the fourth shaft to the third shaft. The transmission ratio of the first gear is then preferably i=4.0. The second gear is preferably obtained when the second shifting element connects the third shaft to the fifth shaft. The transmission ratio of the second gear is preferably i=2.0. Thus, the gear interval between the first and second gears is φ=2.0. The third gear is preferably obtained when the first shifting element connects the drive input shaft to the drive output shaft. The transmission ratio of the third gear is then preferably i=1.0. Hence, the gear interval between the second and third gears is φ=2.0.

In a further preferred embodiment the multi-speed transmission again has a first planetary gearset, a second planetary gearset, a first shifting element and a second shifting element, and at the transmission input rotational movement can be introduced into the multi-speed transmission by a drive input shaft. Preferably, the drive input shaft is connected to the first shifting element and also to the sun gear of the first planetary gearset. The first shifting element is preferably connected by a fourth shaft to the housing and by a third shaft to the ring gear of the first planetary gearset and in addition to the planetary carrier of the second planetary gearset. Preferably, by means of the first shifting element either the drive input shaft can be connected to the third shaft or the third shaft can be connected to the fourth shaft. Also preferably, the ring gear of the second planetary gearset is connected by a drive output shaft to the planetary carrier of the first planetary gearset, and also to the transmission output. Preferably, the sun gear of the second planetary gearset is connected by a fifth shaft to the second shifting element and the second shifting element is connected to the housing by a sixth shaft. The fifth shaft can preferably be connected by means of the second shifting element to the sixth shaft. In this way three different transmission ratios between the transmission input and the transmission output can be obtained. The stationary gear ratio of the first planetary gearset is preferably i₀₁=−3.0 and the stationary gear ratio of the second planetary gearset is preferably i₀₂=−2.0. The first gear can preferably be obtained when the first shifting element connects the third shaft and the fourth shaft to one another. The transmission ratio of the first gear is then preferably i=4.0. The second gear is preferably obtained when the fifth shaft and the sixth shaft are connected to one another by the second shifting element. The transmission ratio of the second gear is preferably i=2.0. This gives a gear interval of φ=2.0 between the first and second gears. The third gear is preferably obtained when the drive input shaft is connected to the third shaft by the first shifting element. The transmission ratio of the third gear is preferably i=1.0. Consequently the gear interval between the second and third gears is φ=2.0.

In a further preferred embodiment, the multi-speed transmission again has a first planetary gearset, a second planetary gearset, a first shifting element and a second shifting element. At the transmission input rotational movement can be introduced into the multi-speed transmission by a drive input shaft. Preferably, the drive input shaft is connected to the first shifting element and also to the sun gear of the first planetary gearset. By way of a fourth shaft the first shifting element is preferably also connected to the housing and, by a third shaft, to the ring gear of the first planetary gearset. The first shifting element is additionally connected to the second shifting element so that in a preferred manner, by means of the first shifting element either the drive input shaft can be connected to the third shaft or the third shaft can be connected to the fourth shaft. Preferably, the planetary carrier of the first planetary gearset is connected by a fifth shaft to the ring gear of the second planetary gearset. The planetary carrier of the second planetary gearset is preferably connected by a drive output shaft to the second shifting element and also to the transmission output. By means of the second shifting element the drive output shaft can preferably be connected to the third shaft. The sun gear of the second planetary gearset is preferably connected by a sixth shaft to the housing. In this way three different transmission ratios can be obtained between the transmission input and the transmission output. The stationary gear ratio of the first planetary gearset preferably has a value of i₀₁=−2.0 and the stationary gear ratio of the second planetary gearset preferably has a value of i₀₂=−3.0. The first gear can preferably be obtained when the first shifting element connects the third shaft to the fourth shaft. Advantageously, the transmission ratio of the first gear is i=5.999. The second gear is advantageously obtained when the second shifting element connects the third shaft and the drive output shaft to one another. The transmission ratio of the second gear is preferably i=3.0. Consequently, there is a gear interval of φ=1.999 between the first gear and the second gear. The third gear is preferably obtained when the first shifting element connects the drive input shaft and the third shaft to one another. The transmission ratio of the third gear is preferably i=1.5. This gives a gear interval of φ=2.0 between the second gear and the third gear.

According to another preferred embodiment, the multi-speed transmission again has a first planetary gearset, a second planetary gearset, a first shifting element and a second shifting element. At the transmission input rotational movement can be introduced into the multi-speed transmission by a drive input shaft. Preferably also, the drive input shaft is connected to the first shifting element and also to the sun gear of the first planetary gearset. Moreover, the first shifting element is preferably connected by a third shaft to the ring gear of the first planetary gearset and by a fourth shaft to the housing. By means of the first shifting element, preferably either the drive input shaft can be connected to the third shaft or the third shaft can be connected to the fourth shaft. The planetary carrier of the first planetary gearset is preferably connected by a fifth shaft to the ring gear of the second planetary gearset. The planetary carrier of the second planetary gearset is preferably connected by way of a drive output shaft to the second shifting element and also to the transmission output. Preferably, the sun gear of the second planetary gearset is connected by a sixth shaft to the second shifting element and the second shifting element by a seventh shaft to the housing. By means of the second shifting element, preferably either the sixth shaft can be connected to the seventh shaft or the seventh shaft can be connected to drive output shaft. In this way four different transmission ratios can be obtained between the transmission input and the transmission output. The stationary gear ratio of the first planetary gearset is preferably i₀₁=−1.518 and the stationary gear ratio of the second planetary gearset is i₀₂=−1.699. The transmission ratio of the first gear is preferably i=4.0, and the first gear can be obtained when the first shifting element connects the third shaft and the fourth shaft to one another and when the second shifting element connects the sixth shaft and the seventh shaft to one another. The transmission ratio of the second gear is preferably i=2.518, and the second gear can be obtained when the first shifting element connects the third and fourth shafts to one another and the second shifting element connects the sixth shaft and the drive output shaft to one another. The gear interval between the first and second gears is c=1.59. The transmission ratio of the third gear is i=1.589. The third gear can be obtained when the first shifting element connects the drive input shaft to the third shaft and when the second shifting element connects the sixth shaft to the seventh shaft. The gear interval between the second and third gears is preferably φ=1.59. The transmission ratio of the fourth gear is preferably i=1.0 and the fourth gear can be obtained when the first shifting element connects the drive input shaft and the third shaft to one another and the second shifting element connects the sixth shaft and the drive output shaft to one another. Preferably, the gear interval between the third gear and the fourth gear is φ=1.59.

In a further design version the multi-speed transmission again has a first planetary gearset, a second planetary gearset, a first shifting element and a second shifting element. At the transmission input rotational movement can be introduced into the multi-speed transmission. Preferably also, the drive input shaft is connected to the first shifting element and also to the sun gear of the first planetary gearset. Preferably, the first shifting element is connected by a third shaft to the ring gear of the first planetary gearset and by a fourth shaft to the housing. By means of the first shifting element, preferably either the drive input shaft can be connected to the third shaft or the third shaft can be connected to the fourth shaft. Preferably also, the planetary carrier of the first planetary gearset is connected by way of a fifth shaft to the planetary carrier of the second planetary gearset. The ring gear of the second planetary gearset is preferably connected by way of a drive output shaft to the transmission output and also to the second shifting element. The second shifting element is preferably connected by a sixth shaft to the sun gear of the second planetary gearset and by a seventh shaft to the housing. By means of the second shifting element, preferably either the drive output shaft can be connected to the sixth shaft or the sixth shaft can be connected to the seventh shaft. In this way four different transmission ratios can be obtained between the transmission input and the transmission output. The stationary gear ratio of the first planetary gearset is preferably i₀₁=−1.518 and the stationary gear ratio of the second planetary gearset is preferably i₀₂=−1.699. The first gear has a transmission ratio of i=2.518, and can be obtained when the first shifting element connects the third shaft and the fourth shaft to one another and the second shifting element connects the drive output shaft and the sixth shaft to one another. The second gear preferably has a transmission ratio of i=1.585 and can preferably be obtained when the first shifting element connects the third and fourth shafts to one another and the second shifting element connects the sixth shaft and the seventh shaft to one another. The gear interval between the first and second gears is preferably φ=1.59. The third gear preferably has a transmission ratio of i=1.0 and can be obtained when the first shifting element connects the drive input shaft and the third shaft to one another and the second shifting element connects the drive output shaft and the sixth shaft to one another. The gear interval between the second and third gears is φ=1.59. The fourth gear preferably has a transmission ratio of i=0.629 and can be obtained when the first shifting element connects the drive input shaft to the third shaft and the second shifting element connects the sixth shaft to the seventh shaft. The gear interval between the third and fourth gears is preferably φ=1.59.

In a further preferred embodiment, the multi-speed transmission again has a first planetary gearset, a second planetary gearset, a first shifting element and a second shifting element. At the transmission input rotational movement can preferably be introduced into the multi-speed transmission by a drive input shaft. Also preferably, the drive input shaft is connected to the first shifting element and also to the planetary carrier of the first planetary gearset. Preferably, the first shifting element is connected by a third shaft to the sun gear of the first planetary gearset and by a fourth shaft to the housing. By means of the first shifting element, preferably either the drive input shaft can be connected to the third shaft or the third shaft can be connected to the fourth shaft. Preferably, the ring gear of the first planetary gearset is connected by a fifth shaft to the sun gear of the second planetary gearset. Also preferably, the transmission output is connected by a drive output shaft to the planetary carrier of the second planetary gearset and also to the second shifting element. Preferably again, the second shifting element is connected by a sixth shaft to the ring gear of the second planetary gearset and also, by way of a seventh shaft, to the housing. Preferably, by means of the second shifting element either the seventh shaft can be connected to the sixth shaft or the sixth shaft can be connected to the drive output shaft. In this way four different transmission ratios between the transmission input and the transmission output can be obtained. Preferably, the stationary gear ratio of the first planetary gearset i₀₁=−1.699 and the stationary gear ratio of the second planetary gearset i₀₂=−1.518. Preferably, the first gear has a transmission ratio of i=2.518 and can be obtained when the second shifting element connects the drive input shaft to the third shaft and the second shifting element connects the sixth shaft to the seventh shaft. The second gear preferably has a transmission ratio of i=1.585 and is obtained when the first shifting element connects the third shaft to the fourth shaft and the second shifting element connects the sixth shaft to the seventh shaft. The gear interval between the first and second gears is preferably φ=1.59. The third gear preferably has a transmission ratio of i=1.0 and is obtained when the first shifting element connects the drive input shaft to the third shaft and the second shifting element connects the sixth shaft to the drive output shaft. The gear interval between the second and third gears is preferably φ=1.59. The fourth gear preferably has a transmission ratio of i=0.629 and can be obtained when the first shifting element connects the third shaft to the fourth shaft and the second shifting element connects the sixth shaft to the drive output shaft. The gear interval between the third and fourth gears is preferably 1.59.

According to a further preferred embodiment the multi-speed transmission comprises one planetary and one shifting element. At the transmission input, rotational movement can preferably be introduced into the multi-speed transmission by way of a drive input shaft. Also preferably, the drive input shaft is connected to the ring gear of the planetary gearset. The planetary carrier of the planetary gearset is preferably connected by a drive output shaft to the transmission output and is also connected to the shifting element. The shifting element is preferably connected by a third shaft to the sun gear of the planetary gearset and by a fourth shaft to the housing. By means of the shifting element either the drive output shaft can be connected to the third shaft, or the third shaft can be connected to the fourth shaft, whereby two different transmission ratios between the transmission input and the transmission output can be obtained. The stationary gear ratio of the planetary gearset is preferably i₀₁=−1.6. Preferably also, the first gear has a transmission ratio of i=1.625 and the second gear a transmission ratio of i=1.0. The gear interval between the first and second gears is preferably φ=1.625.

Preferably also, a gear interval between two adjacent transmission ratios is 1.6≦φ≦2. Preferably, an adaptation of an overall transmission ratio of the multi-speed transmission takes place by way of one or more of the transmission stages upstream and/or downstream from the multi-speed transmission.

Particularly advantageously, particularly in multi-speed transmissions with more than two gears the transmission ratios should be chosen such that the gear intervals between the individual gears are substantially the same. Particularly when electric motors are used as drive elements, this provides a wider operating range. At the same time, the gear intervals between the individual gears should not be made too big since that would lead to large rotational speed differences in the transmission or its shifting elements, resulting in premature damage and increased wear. Particularly preferably, the gears in the multi-speed transmission arrangements just described have the same rotation directions as one another in each case, which means that no rotation direction reversal takes place between the gears. Preferably therefore, by virtue of the multi-speed transmissions described, depending on the rotation direction imposed by the drive element or elements a corresponding number of forward or reversing gears are provided. In the cases described the transmission ratios mentioned are only given as examples. Other multi-speed transmission arrangements with different transmission ratios and stationary gear ratios are certainly conceivable.

Upstream and/or downstream transmission stages are understood to mean that one or more further transmission stages can be provided on the drive input side and/or on the drive output side. By virtue of the transmission stages either the rotational movement can just be transmitted with a transmission ratio i=1, or a further step-down or step-up of the rotation speed or the torque is also conceivable. For example, the transmission stage could be a spur gear stage, but also transmission by way of a chain or belt drive is certainly conceivable as well. Arrangements with bevel gearwheels are also conceivable.

### BRIEF DESCRIPTION OF THE DRAWINGS

Below, examples of the invention will be explained in more detail with reference to the attached figures, which show:

FIG. 1: A schematic representation of a first embodiment of a multi-speed transmission according to the invention;

FIG. 2: A schematic representation of a second embodiment of a multi-speed transmission according to the invention;

FIG. 3: A schematic representation of a third embodiment of a multi-speed transmission according to the invention;

FIG. 4: A schematic representation of a fourth embodiment of a multi-speed transmission according to the invention;

FIG. 5: A schematic representation of a fifth embodiment of a multi-speed transmission according to the invention;

FIG. 6: A schematic representation of a sixth embodiment of a multi-speed transmission according to the invention;

FIG. 7: A schematic representation of a seventh embodiment of a multi-speed transmission according to the invention;

FIG. 8: A schematic representation of an eighth embodiment of a multi-speed transmission according to the invention;

FIG. 9: A schematic representation of a ninth embodiment of a multi-speed transmission according to the invention;

FIG. 10: A schematic representation of a tenth embodiment of a multi-speed transmission according to the invention;

FIG. 11: A schematic representation of an eleventh embodiment of a multi-speed transmission according to the invention;

FIG. 12: A schematic representation of a twelfth embodiment of a multi-speed transmission according to the invention;

FIG. 13: A schematic representation of a thirteenth embodiment of a multi-speed transmission according to the invention;

FIG. 14: A schematic representation of a fourteenth embodiment of a multi-speed transmission according to the invention;

FIGS. 15 to 18: Schematic representations of further arrangements of the first embodiment of a multi-speed transmission according to the invention;

FIGS. 19 to 24: Schematic representations of further arrangements of the second embodiment of a multi-speed transmission according to the invention;

FIGS. 25 to 28: Schematic representations of further arrangements of the third embodiment of a multi-speed transmission according to the invention;

FIGS. 29 to 31: Schematic representations of further arrangements of the fourth embodiment of a multi-speed transmission according to the invention;

FIGS. 32 to 34: Schematic representations of further arrangements of the fifth embodiment of a multi-speed transmission according to the invention;

FIGS. 35 to 36: Schematic representations of further arrangements of the sixth embodiment of a multi-speed transmission according to the invention;

FIGS. 37 to 42: Schematic representations of further arrangements of the seventh embodiment of a multi-speed transmission according to the invention;

FIGS. 43 to 45: Schematic representations of further arrangements of the eighth embodiment of a multi-speed transmission according to the invention;

FIGS. 46 to 49: Schematic representations of further arrangements of the ninth embodiment of a multi-speed transmission according to the invention;

FIGS. 50 to 52: Schematic representations of further arrangements of the tenth embodiment of a multi-speed transmission according to the invention;

FIGS. 53 to 58: Schematic representations of further arrangements of the eleventh embodiment of a multi-speed transmission according to the invention;

FIGS. 59 to 62: Schematic representations of further arrangements of the twelfth embodiment of a multi-speed transmission according to the invention;

FIGS. 63 to 65: Schematic representations of further arrangements of the thirteenth embodiment of a multi-speed transmission according to the invention;

FIGS. 66 to 68: Schematic representations of further arrangements of the fourteenth embodiment of a multi-speed transmission according to the invention;

FIG. 69: A schematic representation of a fifteenth embodiment of a multi-speed transmission according to the invention;

FIG. 70: A schematic representation of a further arrangement of the fifteenth embodiment of a multi-speed transmission according to the invention.

### DETAILED DESCRIPTION OF THE PREFERRED EMBODIMENTS

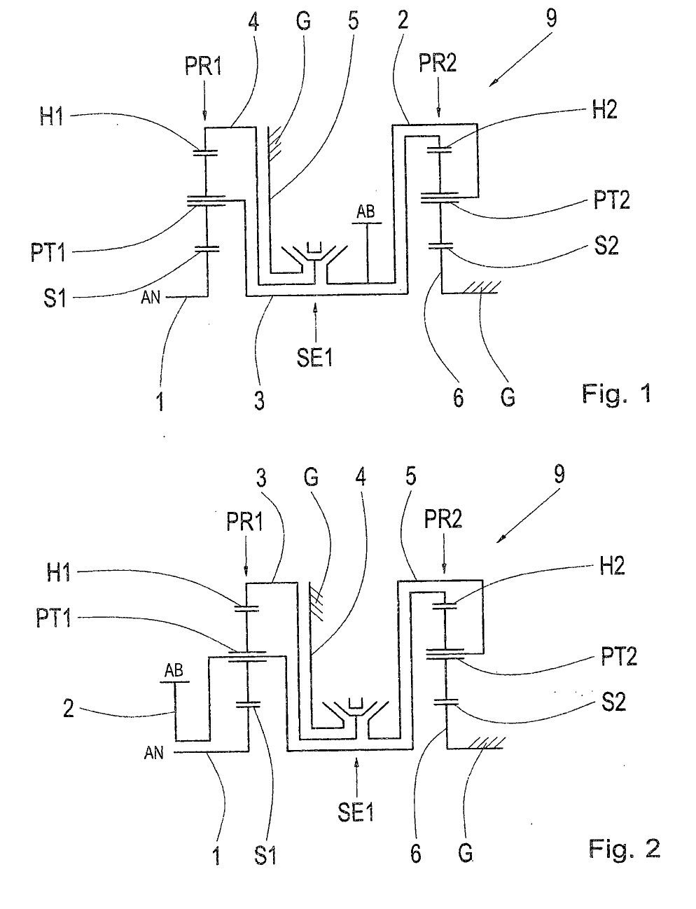

FIG. 1 shows a schematic representation of a first embodiment of a multi-speed transmission 9 according to the invention. The multi-speed transmission 9 has a first planetary gearset PR1, a second planetary gearset PR2, and a first shifting element SE1. In this case the first shifting element SE1 is arranged between the first planetary gearset PR1 and the second planetary gearset PR2. At a transmission input AN a sun gear S1 of the first planetary gearset PR1 is connected to a drive input shaft 1. By means of the drive input shaft 1 rotational movement can be introduced into the multi-speed transmission 9. Besides the first sun gear S1 the first planetary gearset PR1 has a first planetary carrier PT1 and a first ring gear H1. Not shown in the figure are planetary gearwheels arranged to rotate on the first planetary carrier PT1. The planetary carrier PT1 of the first planetary gearset PR1 is connected by a third shaft 3 to a ring gear H2 of the second planetary gearset PR2. The ring gear H1 of the first planetary gearset PR1 is connected on one side by a fourth shaft 4 to the first shifting element SE1. On another side the first shifting element SE1 is connected by a fifth shaft 5 to a housing G. On a further side the first shifting element SE1 is connected by a drive output shaft 2 to a transmission output AB and also to a planetary carrier PT2 of the second planetary gearset PR2. A sun gear S2 of the second planetary gearset PR2 is connected to the housing G by a sixth shaft 6.

The first shifting element SE1 is in this case made as a dual shifting element. This means that with only one actuator, depending on the shift position thereof the fourth shaft 4 can be connected to the fifth shaft 5 or the fourth shaft 4 can be connected to the drive output shaft 2. The first gear can be obtained when the fourth shaft 4 is connected by the first shifting element SE1 to the fifth shaft 5. The second gear can be obtained when the first shifting element SE1 connects the fourth shaft 4 to the drive output shaft 2. The transmission output AB is positioned between the first shifting element SE1 and the second planetary gearset PR2. In the present case the transmission output AB is in the form of a spur gear. Thus, depending on the shifting position of the first shifting element SE1 two different transmission ratios can be obtained between the transmission input AN and the transmission output AB. The two planetary gearsets PR1, PR2 are both in the form of minus planetary gearsets. Here, the two planetary gearsets PR1, PR2 are arranged coaxially with a rotational axis (not shown) passing through the drive input shaft.

Since the fifth shaft 5 is connected to the housing G, when the first shifting element SE1 is actuated correspondingly the fourth shaft 4 can be braked or held fixed on the housing G. Since the sixth shaft 6 is connected on the one hand to the sun gear S2 of the second planetary gearset PR2 and on the other hand to the housing G, the sun gear S2 of the second planetary gearset PR2 is always at rest, i.e. it does not rotate.

FIG. 2 shows a second embodiment of the multi-speed transmission 9, represented schematically. In this case the multi-speed transmission 9 also has a first planetary gearset PR1, a second planetary gearset PR2 and a first shifting element SE1. At a transmission input a sun gear S1 of the first planetary gearset PR1 is connected to a drive input shaft 1. By way of this drive input shaft 1 a torque, for example from a drive element, can be introduced into the multi-speed transmission 9. Starting on one side of the transmission input AN of the multi-speed transmission 9, there are arranged a transmission output AB, the first and second planetary gearsets PR1, PR2 and the first shifting element SE1, in the sequence transmission output AB, first planetary gearset PR1, first shifting element SE1 and second planetary gearset PR2. The first shifting element SE1 is again arranged between the first planetary gearset PR1 and the second planetary gearset PR2. In this embodiment the transmission input AN and the transmission output AB are on the same side of the multi-speed transmission 9. By way of a drive output shaft 2 the transmission output AB is connected to a planetary carrier PT1 of the first planetary gearset PR1 and also to a ring gear H2 of the second planetary gearset PR2. A ring gear H1 of the first planetary gearset PR1 is connected by way of a third shaft 3 to a first side of the first shifting element SE1. The first shifting element SE1 is connected, on another side, to a housing G by a fourth shaft 4. On a further side the first shifting element SE1 is connected by a fifth shaft 5 to a planetary carrier PT2 of the second planetary gearset PR2. A sun gear S2 of the second planetary gearset PR2 is connected by a sixth shaft 6 to the housing G. Again, this means that the sun gear S2 of the second planetary gearset PR2 is stationary, i.e. it does not rotate.

The first shifting element SE1 is again made as a dual shifting element. This means that the first shifting element SE1 only has one actuator. In this case the first gear can be obtained when the third shaft 3 is connected by the first shifting element SE1 to the fourth shaft 4. This means that the third shaft 3 can be braked or fixed relative to the housing G by means of the first shifting element SE1 and the fourth shaft 4. The second gear can be obtained when the first shifting element SE1 connects the third shaft 3 to the fifth shaft 5.

The planetary gearset PR1, the planetary gearset PR2, the transmission input AN, the transmission output AB and the first shifting element SE1 are all arranged coaxially with a rotational axis (not shown) that passes through the drive input shaft 1.

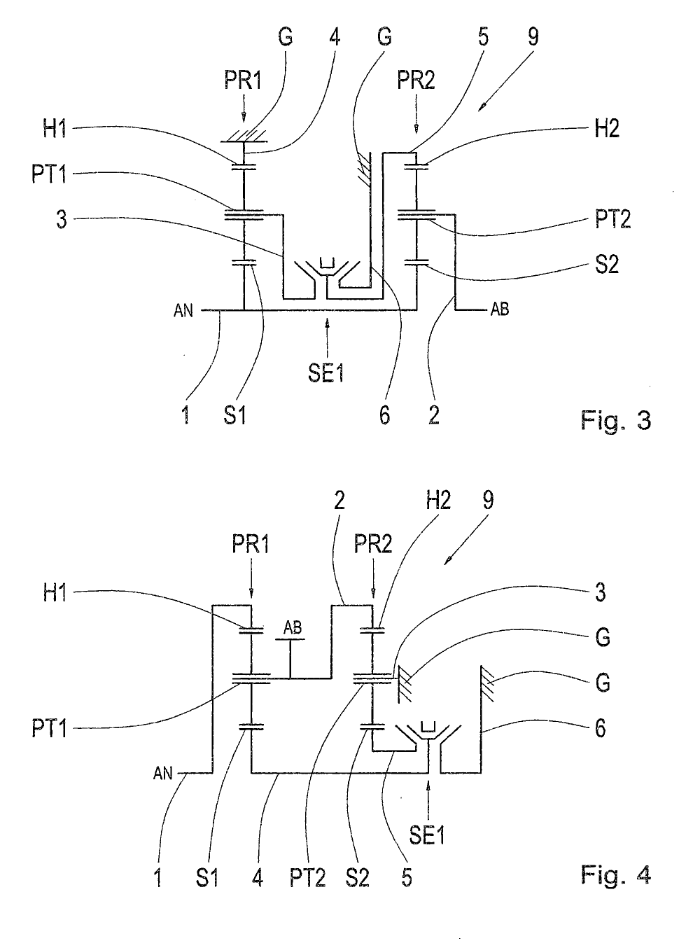

FIG. 3 shows a schematic representation of a third embodiment of the multi-speed transmission 9 according to the invention. In contrast to the embodiments described in FIGS. 1 and 2, in this embodiment a sun gear S1 of the first planetary gearset PR1 is connected by way of the drive input shaft 1 to the transmission input AN and to the sun gear S2 of the second planetary gearset PR2. The planetary carrier PT1 of the first planetary gearset PR1 is connected by the third shaft 3 to the first shifting element SE1. The ring gear H1 of the first planetary gearset PR1 is connected by way of the fourth shaft 4 to the housing G. On another side the first shifting element SE1 is connected by the fifth shaft 5 to the ring gear H2 of the second planetary gearset PR2. On a further side the first shifting element SE1 is connected by the sixth shaft 6 to the housing G. The planetary carrier PT2 of the second planetary gearset PR2 is connected by the drive output shaft 2 to the transmission output AB.

The transmission input AN and the transmission output AB are at respectively opposite ends of the multi-speed transmission 9. Between the transmission input AN and the transmission output AB are arranged the first planetary gearset PR1, the first shifting element SE1 and the second planetary gearset PR2, in the sequence mentioned.

The first shifting element SE1 is again made as a dual shifting element. By means of the first shifting element SE1 the third shaft 3 can be connected to the fifth shaft 5. This gives the second gear of the transmission. Furthermore, by means of the first shifting element SE1 the fifth shaft 5 can be connected to the sixth shaft 6. Since the sixth shaft 6 is connected to the housing G, in the shift condition of the first shifting element SE1 just described the fifth shaft 5 and hence also the ring gear H2 of the second planetary gearset PR2 can be braked or fixed relative to the housing G. In that way the first gear of the multi-speed transmission 9 can be obtained.

FIG. 4 shows a schematic representation of a fourth embodiment of the multi-speed transmission 9 according to the invention. The embodiment shown in FIG. 4 differs from the embodiments of the multi-speed transmission 9 described until now in that at the transmission input, the drive input shaft 1 is connected to the ring gear H1 of the first planetary gearset PR1. The planetary carrier PT1 of the first planetary gearset PR1 is connected by the drive output shaft 2 to the transmission output AB and also to the ring gear H2 of the second planetary gearset PR2. The sun gear S1 of the first planetary gearset PR1 is connected to the first shifting element SE1 by way of the fourth shaft 4. The planetary carrier PT2 of the second planetary gearset PR2 is connected by the third shaft 3 to the housing G, i.e. the planetary carrier PT2 of the second planetary gearset PR2 is fixed, in other words it does not rotate. The sun gear S2 of the second planetary gearset PR2 is also connected by the fifth shaft 5 to the first shifting element SE1. The latter is also connected by the sixth shaft 6 to the housing G. Starting from the transmission input AN, the first planetary gearset PR1, the transmission output AB, the second planetary gearset PR2 and the first shifting element SE1 are arranged in the sequence just mentioned. The first gear of the multi-speed transmission 9 can be obtained when the first shifting element SE1 connects the fifth shaft 5 to the fourth shaft 4. In contrast, the second gear of the multi-speed transmission 9 can be obtained when the fourth shaft 4 is connected to the sixth shaft 6, whereby the fourth shaft 4 can be braked or fixed relative to the housing G.

The planetary gearsets PR1, PR2, the transmission output AB and the first shifting element SE1 are, as described earlier, arranged coaxially with a rotational axis (not shown) of the drive input shaft 1.

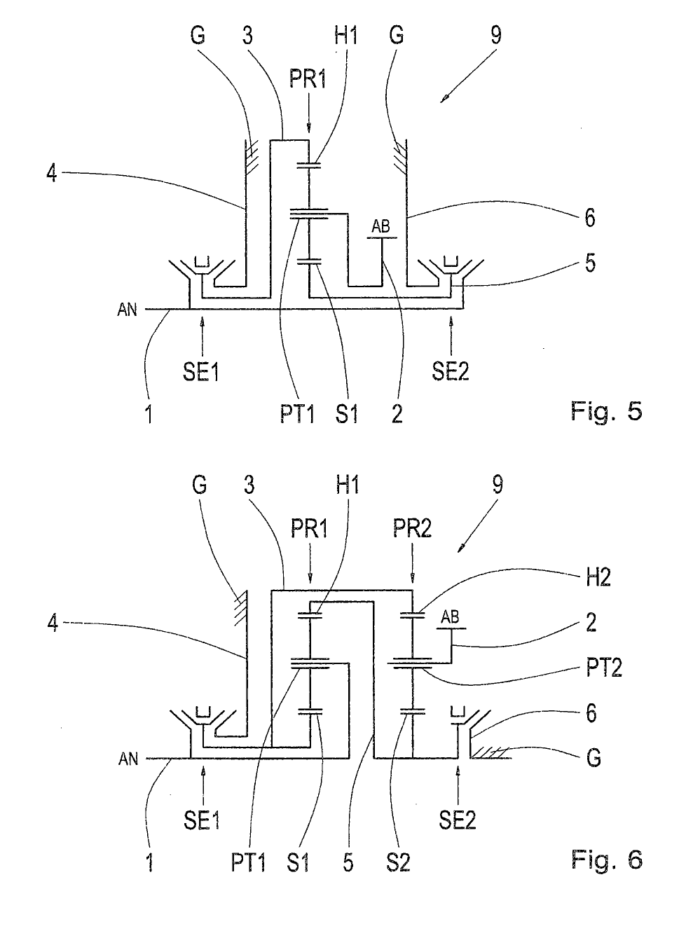

FIG. 5 shows a schematic representation of a fifth embodiment of the multi-speed transmission 9 according to the invention. In contrast to the embodiments described previously, in the present case the multi-speed transmission 9 comprises a first shifting element SE1, a first planetary gearset PR1 and a second shifting element SE2. Starting from the transmission input AN, the first shifting element SE1, the first planetary gearset PR1, the transmission output AB and the second shifting element SE2 are arranged in the sequence just mentioned.

The drive input shaft 1 is connected to the first shifting element SE1 and also to the second shifting element SE2. The first shifting element SE1 is also connected by way of the third shaft 3 to the ring gear H1 of the first planetary gearset PR1. In addition, the first shifting element SE1 is connected by the fourth shaft 4 to the housing G. The planetary carrier PT1 of the first planetary gearset PR1 is connected by way of the drive output shaft 2 to the transmission output AB. By way of the fifth shaft 5, the sun gear S1 of the first planetary gearset PR1 is connected to the second shifting element SE2. The second shifting element SE2 is also connected by the sixth shaft 6 to the housing G.

The two shifting elements SE1, SE2 are in each case made as dual shifting elements. By virtue of the arrangement described a total of three different transmission ratios, in other words three gears can be obtained by the multi-speed transmission 9. The first gear can be obtained when the first shifting element SE1 connects the drive input shaft 1 to the third shaft 3 and the second shifting element SE2 connects the fifth shaft 5 to the sixth shaft 6, i.e. the third shaft 3 can be braked or fixed relative to the housing G. The second gear is obtained when the first shifting element SE1 connects the third shaft 3 to the fourth shaft 4, whereby the third shaft 3 can be braked or fixed relative to the housing G. Furthermore, by means of the second shifting element SE2 the drive input shaft 1 is connected to the fifth shaft 5. The third gear of the multi-speed transmission 9 can be obtained when the first shifting element SE1 connects the drive input shaft 1 to the third shaft 3 and the second shifting element SE2 connects the drive input shaft 1 to the fifth shaft 5.

The shifting elements SE1, SE2, the first planetary gearset PR1 and the transmission output AB are arranged coaxially with a rotational axis (not shown) of the drive input shaft 1.

FIG. 6 shows a schematic representation of a sixth embodiment of the multi-speed transmission 9 according to the invention. Starting from the transmission input AN, there are arranged in the following sequence a first shifting element SE1, a first planetary gearset PR1, a second planetary gearset PR2, a transmission output AB and a second shifting element SE2. By means of the drive input shaft 1 the transmission input AN is connected to the first shifting element SE1 and also to the planetary carrier PT1 of the first planetary gearset PR1. By way of the third shaft 3 the first shifting element SE1 is also connected to the sun gear S1 of the first planetary gearset PR1 and to the ring gear H2 of the second planetary gearset PR2. By way of the fourth shaft 4 the first shifting element SE1 is also connected to the housing G. The planetary carrier PT2 of the second planetary gearset PR2 is connected to the transmission output by the drive output shaft 2. The ring gear H1 of the first planetary gearset PR1 is connected by the fifth shaft 5 to the sun gear S2 of the second planetary gearset PR2, and also to the second shifting element SE2. Moreover, the second shifting element SE2 is connected by the sixth shaft 6 to the housing G.

With this embodiment of the multi-speed transmission 9 a total of three different transmission ratios can be obtained. The first shifting element SE1 is made as a dual shifting element. By virtue of the first shifting element SE1 the first gear can be obtained when the third shaft 3 is connected to the fourth shaft 4, whereby the third shaft 3 can be braked or fixed relative to the housing G. The second gear can be obtained by means of the first shifting element SE1 when the drive input shaft 1 is connected to the third shaft 3. The third gear can be obtained when the second shifting element SE2 connects the fifth shaft 5 to the sixth shaft 6. Thereby the fifth shaft 5 can be braked or fixed relative to the housing G.

The shifting elements SE1, SE2, the planetary gearsets PR1, PR2 and the transmission output AB are arranged coaxially with a rotational axis (not shown) of the drive input shaft.

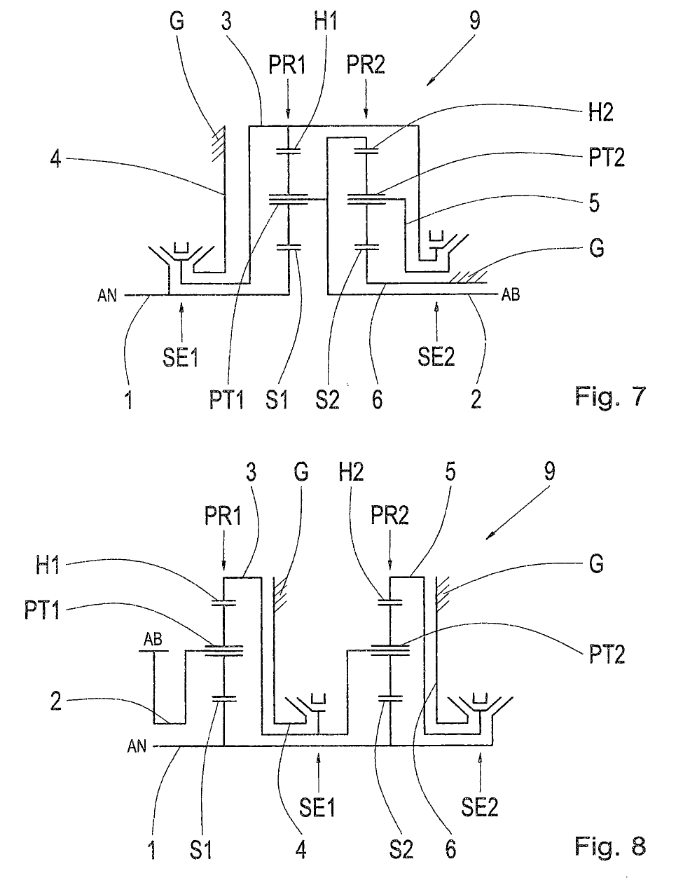

FIG. 7 shows a schematic representation of a seventh embodiment of the multi-speed transmission 9 according to the invention. This embodiment differs from the embodiment shown in FIG. 6 in that the drive input shaft 1 connects the transmission input AN to the first shifting element SE1 and also to the sun gear S1 of the first planetary gearset PR1. The first shifting element SE1 is connected on the one hand also to the third shaft 3, whereby the third shaft 3 for its part is further connected to the ring gear H1 of the first planetary gearset PR1 and to the second shifting element SE2. Furthermore, the first shifting element SE1 is connected to the housing G by the fourth shaft 4. The planetary carrier PT1 of the first planetary gearset PR1 is connected by the drive output shaft 2 to the transmission output AB and to the ring gear H2 of the second planetary gearset PR2. The planetary carrier PT2 of the second planetary gearset PR2 is connected by the fifth shaft 5 to the second shifting element SE2. By way of the sixth shaft 6 the sun gear S2 of the second planetary gearset PR2 is connected to the housing G.

With this embodiment of the multi-speed transmission 9 three different transmission ratios between the transmission input AN and the transmission output AB can be obtained. The first gear can be obtained when the first shifting element SE1 connects the third shaft 3 to the fourth shaft 4, whereby the third shaft 3 and the components and elements connected thereto are braked or fixed relative to the housing G by way of the fourth shaft 4. The second gear can be obtained when the second shifting element SE2 connects the fifth shaft 5 to the third shaft 3. The third gear can be obtained when the first shifting element SE1 connects the drive input shaft 1 to the third shaft 3.

Starting from the transmission input AN, the first shifting element SE1, the first planetary gearset PR1, the second planetary gearset PR2, the second shifting element SE2 and the transmission output AB are arranged in the sequence just mentioned. The transmission input AN and the transmission output AB are arranged coaxially, respectively at opposite ends of the multi-speed transmission 9. Furthermore, the shifting elements SE1, SE2 and the planetary gearsets PR1, PR2 are also arranged coaxially with a rotational axis (not shown) of the drive input shaft.

FIG. 8 shows a schematic representation of an eighth embodiment of the multi-speed transmission 9 according to the invention. Starting from the transmission input AN, the transmission output AB, the first planetary gearset PR1, the first shifting element SE1, the second planetary gearset PR2 and the second shifting element SE2 are arranged in the sequence just mentioned. The second shifting element SE2 is made as a dual shifting element.

The drive input shaft 1 is connected to the sun gear S1 of the first planetary gearset PR1, to the sun gear S2 of the second planetary gearset PR2 and, further, to the second shifting element SE2. The planetary carrier PT1 of the first planetary gearset PR1 is connected to the transmission output AB by the drive output shaft 2. The ring gear H1 of the first planetary gearset PR1 is connected by the third shaft 3 to the first shifting element SE1 and, further, to the planetary carrier PT2 of the second planetary gearset PR2. The first shifting element SE1 is connected by the fourth shaft 4 to the housing G. The ring gear H2 of the second planetary gearset PR2 is connected by the fifth shaft 5 to the second shifting element SE2. By way of the sixth shaft 6, the second shifting element SE2 is also connected to the housing G.

The second shifting element SE2 is made as a dual shifting element. With this embodiment of the multi-speed transmission three different transmission ratios between the transmission input and the transmission output can be obtained. The first gear can be obtained when the first shifting element SE1 connects the third shaft 3 to the fourth shaft 4 and the third shaft 3 can thereby be braked or fixed relative to the housing G. The second gear can be obtained when the second shifting element SE2 connects the fifth shaft 5 to the sixth shaft 6 so that the fifth shaft 5 can be braked or fixed relative to the housing G. The third gear can be obtained when the second shifting element SE2 connects the drive input shaft 1 to the fifth shaft 5. The planetary gearsets PR1, PR2, the shifting elements SE1, SE2 and the transmission output AB are arranged coaxially with a rotational axis (not shown) of the drive input shaft 1.

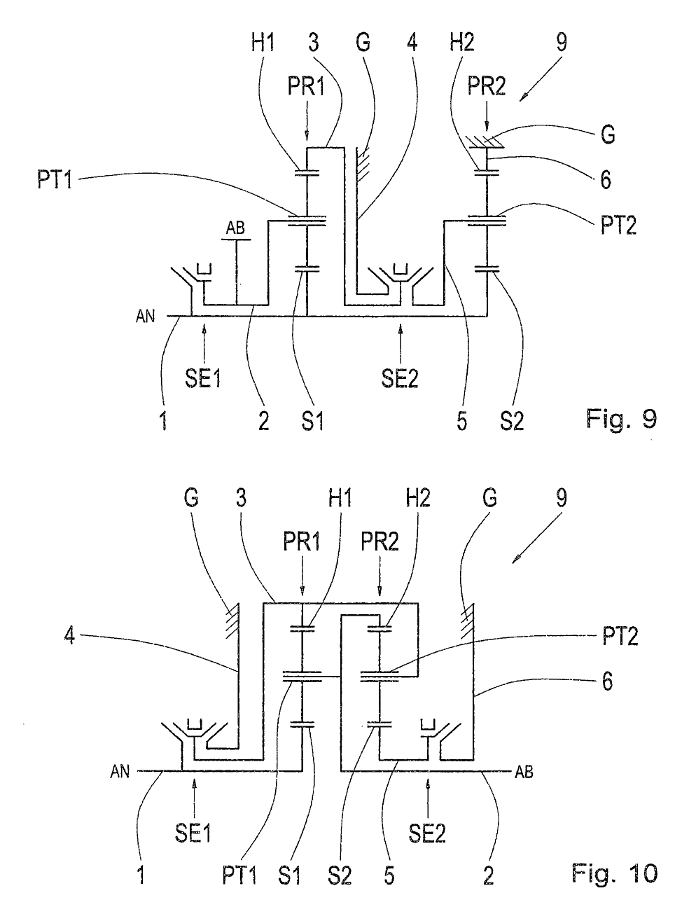

FIG. 9 shows a schematic representation of a ninth embodiment of the multi-speed transmission. In this case, starting from a transmission input a first shifting element SE1, a transmission output AB, a first planetary gearset PR1, a second shifting element SE2 and a second planetary gearset PR2 are arranged in the sequence just mentioned. By way of the drive input shaft 1 the first shifting element SE1, the sun gear S1 of the first planetary gearset PR1 and the sun gear S2 of the second planetary gearset PR2 are connected to one another. The first shifting element SE1 is also connected by the drive output shaft 2 to the transmission output AB and to the planetary carrier PT1 of the first planetary gearset PR1. The ring gear H1 of the first planetary gearset PR1 is connected by the third shaft 3 to the second shifting element SE2. The latter is also connected by way of the fourth shaft 4 to the housing G and, on another side, by the fifth shaft 5 to the planetary carrier PT2. The ring gear H2 of the second planetary gearset PR2 is connected to the housing G by the sixth shaft 6. In this case too the second shifting element SE2 is made as a dual shifting element.

By virtue of the arrangement just described, with the multi-speed transmission 9 three different transmission ratios can be obtained between the transmission input AN and the transmission output AB. The first gear can be obtained when the second shifting element SE2 connects the third shaft 3 to the fourth shaft 4, whereby the third shaft 3 can be braked or fixed relative to the housing G. The second gear of the multi-speed transmission 9 can be obtained when the second shifting element SE2 connects the third shaft 3 to the fifth shaft 5. The third gear of the multi-speed transmission 9 can be obtained when the first shifting element SE1 connects the drive input shaft 1 to the drive output shaft 2.

The shifting elements SE1, SE2, the planetary gearsets PR1, PR2 and the transmission output AB are arranged coaxially with a rotational axis (not shown) of the drive input shaft 1.

FIG. 10 shows a schematic representation of a tenth embodiment of the multi-speed transmission 9 according to the invention. In this case, starting from a transmission input AN a first shifting element SE1, a first planetary gearset PR1, a second planetary gearset PR2, a second shifting element SE2 and a transmission output AB are arranged in the sequence just mentioned. By means of the drive input shaft 1 the first shifting element SE1 is connected to the sun gear S1 of the first planetary gearset PR1. The first shifting element SE1 is also connected by a third shaft 3 to the ring gear H1 of the first planetary gearset PR1 and to the planetary carrier PT2 of the second planetary gearset PR2. By means of the fourth shaft 4, the first shifting element SE1 is also connected to the housing G. The planetary carrier PT1 of the first planetary gearset PR1 is connected by the drive output shaft 2 to the ring gear H2 of the second planetary gearset PR2 and to the transmission output AB. The sun gear S2 of the second planetary gearset PR2 is connected by the fifth shaft 5 to the second shifting element SE2. The latter is also connected by the sixth shaft 6 to the housing G.

By virtue of the embodiment of the multi-speed transmission 9 shown here, three different transmission ratios can be obtained between the transmission input AN and the transmission output AB. The first gear of the multi-speed transmission 9 can be obtained when the first shifting element SE1 connects the third shaft 3 to the fourth shaft 4, so that the third shaft 3 can be braked or fixed relative to the housing G. The second gear can be obtained when the second shifting element SE2 connects the fifth shaft 5 to the sixth shaft 6 and thereby the fifth shaft 5 can be braked or fixed relative to the housing G. The third gear can be obtained when the first shifting element SE1 connects the drive input shaft 1 to the third shaft 3. Here, the first shifting element SE1 is made as a dual shifting element.

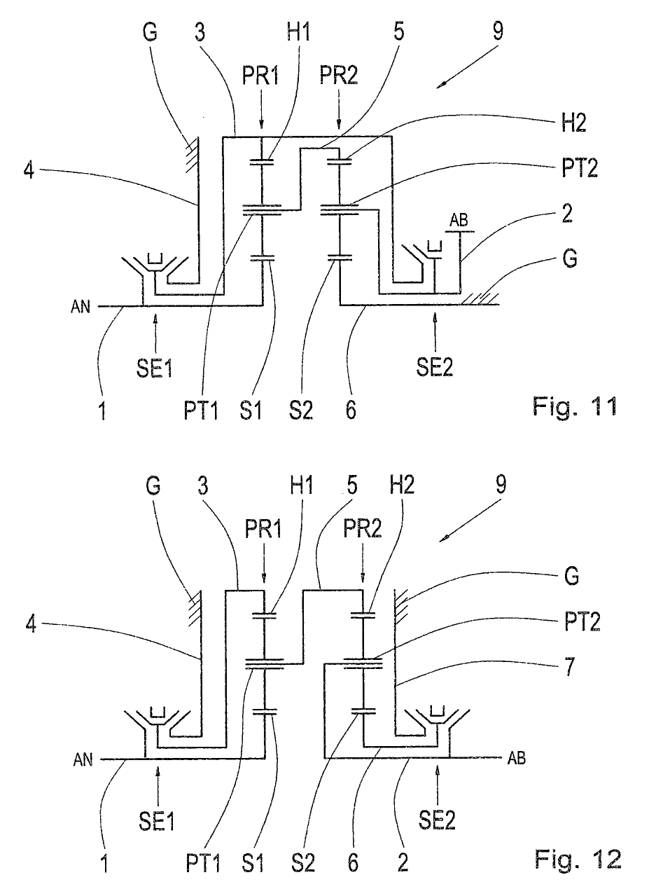

FIG. 11 shows an eleventh embodiment of the multi-speed transmission 9 according to the invention. The embodiment shown in FIG. 11 differs from the embodiment described in FIG. 10, in that the first shifting element SE1 is connected by the third shaft 3 to the ring gear H1 of the first planetary gearset PR1 and also to the second shifting element SE2. Moreover, the first planetary carrier PT1 of the first planetary gearset PR1 is connected by the fifth shaft 5 to the ring gear H2 of the second planetary gearset PR2. The planetary carrier PT2 of the second planetary gearset PR2 is connected by the drive output shaft 2 to the second shifting element SE2 and also to the transmission output AB. The sun gear S2 of the second planetary gearset PR2 is connected by the sixth shaft 6 to the housing G.

By means of the embodiment of the multi-speed transmission 9 shown in FIG. 11 three different transmission ratios can be obtained between the transmission input AN and the transmission output AB. The first gear can be obtained when the first shifting element SE1 connects the third shaft 3 to the fourth shaft 4, whereby the third shaft 3 can be braked or fixed relative to the housing G. The second gear can be obtained when the second shifting element SE2 connects the drive output shaft 2 to the third shaft 3. The third gear can be obtained when the first shifting element SE1 connects the drive input shaft 1 to the third shaft 3.

FIG. 12 shows a schematic representation of a twelfth embodiment of the multi-speed transmission 9 according to the invention. This differs from the embodiment described in FIG. 11 in that the first shifting element SE1 is connected by the third shaft 3 to the ring gear H1 of the first planetary gearset PR1. Moreover, the second planetary carrier PT2 of the second planetary gearset PR2 is connected by the drive output shaft 2 to the second shifting element SE2 and also to the transmission output AB. Furthermore, the second shifting element SE2 is made as a dual shifting element. The sun gear S2 of the second planetary gearset PR2 is also connected to the second shifting element SE2. By way of a seventh shaft 7, the second shifting element SE2 is connected to the housing G.

In this case, with the multi-speed transmission 9 shown here four different transmission ratios can be obtained between the transmission input AN and the transmission output AB. The first gear can be obtained when the first shifting element SE1 connects the third shaft 3 to the fourth shaft 4 and thereby the third shaft can be braked or fixed relative to the housing G. At the same time, the second shifting element SE2 connects the sixth shaft 6 to the seventh shaft 7 whereby the sixth shaft 6 can be braked or fixed relative to the housing G. The second gear can be obtained when, again, the third shaft 3 is connected by the first shifting element SE1 to the fourth shaft 4. In contrast to the first gear, however, in this case the sixth shaft 6 is connected by the second shifting element SE2 to the drive output shaft 2. The third gear can be obtained when, as already in the first gear, the second shifting element SE2 connects the sixth shaft 6 to the seventh shaft 7. In addition, the first shifting element SE1 connects the drive input shaft 1 to the third shaft 3. The fourth gear can be obtained when the first shifting element SE1 connects the drive input shaft 1 to the third shaft 3 and at the same time the second shifting element SE2 connects the drive output shaft 2 to the sixth shaft 6.

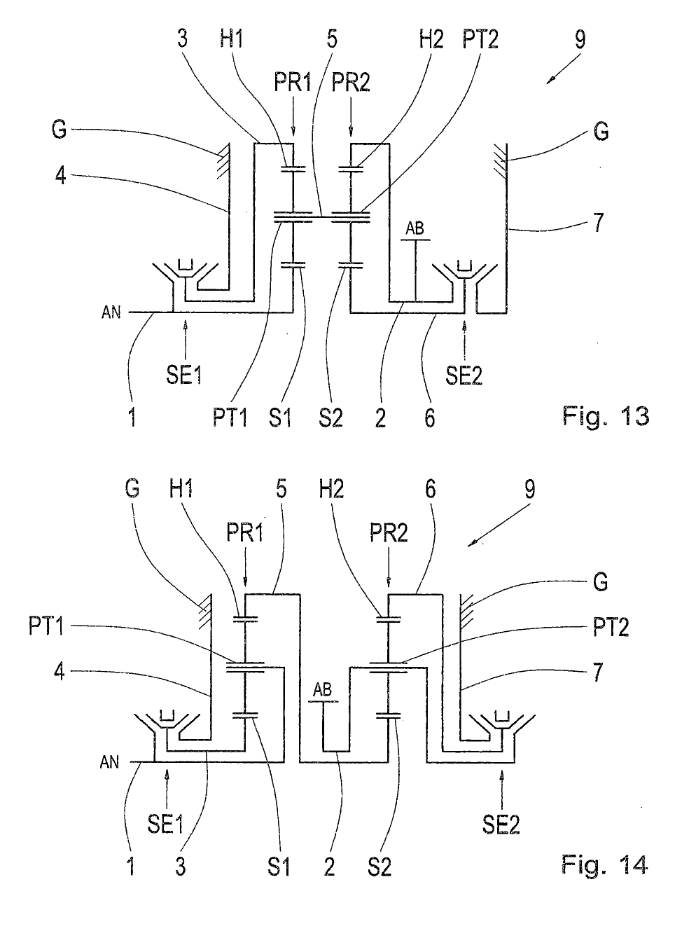

FIG. 13 shows a schematic representation of a thirteenth embodiment of the multi-speed transmission 9 according to the invention. In this case, starting from a transmission input AN a first shifting element SE1, a first planetary gearset PR1, a second planetary gearset PR2, a transmission output AB and a second shifting element SE2 are arranged in the sequence just mentioned, coaxially with a rotational axis (not shown) of the drive input shaft 1. By way of the drive input shaft 1 the first shifting element SE1 is connected to the sun gear S1 of the first planetary gearset PR1. In addition the first shifting element SE1 is connected by the third shaft 3 to the ring gear H1 of the first planetary gearset PR1. Furthermore, the first shifting element SE1, which is made as a dual shifting element, is connected to the housing G by the fourth shaft 4. The planetary carrier PT1 of the first planetary gearset PR1 is connected by the fifth shaft 5 to the planetary carrier PT2 of the second planetary gearset PR2. The ring gear H2 of the second planetary gearset PR2 is connected by the drive output shaft 2 to the transmission output AB and also to the second shifting element SE2. The sun gear S2 of the second planetary gearset PR2 is also connected by the sixth shaft 6 to the second shifting element SE2, whereby the second shifting element SE2, made as a dual shifting element, is also connected by way of the seventh shaft 7 to the housing G.

By means of the arrangement of the multi-speed transmission 9 just described four different transmission ratios can be obtained between the transmission input AN and the transmission output AB. The first gear can be obtained when the first shifting element SE1 connects the third shaft 3 to the fourth shaft 4 and the third shaft 3 can therefore be braked or fixed relative to the housing G. At the same time, the second shifting element SE2 connects the drive output shaft 2 to the sixth shaft 6. The second gear can be obtained when the first shifting element SE1 again connects the third shaft 3 to the fourth shaft 4. Moreover, at the same time the second shifting element SE2 connects the sixth shaft 6 to the seventh shaft 7 and thereby the sixth shaft can be braked or fixed relative to the housing G. The third gear can be obtained when the first shifting element SE1 connects the drive input shaft 1 to the third shaft 3 and at the same time the second shifting element SE2 connects the drive output shaft to the sixth shaft 6. The fourth gear can be obtained when the first shifting element SE1 again connects the drive input shaft 1 to the third shaft 3 and at the same time the second shifting element SE2 connects the sixth shaft 6 to the seventh shaft 7.

FIG. 14 shows a fourteenth embodiment of the multi-speed transmission 9 according to the invention. In this case, starting from a transmission input AN a first shifting element SE1, a first planetary gearset PR1, a transmission output AB, a second planetary gearset PR2 and a second shifting element SE2 are arranged in the sequence just mentioned, coaxially with a rotational axis (not shown) of the drive input shaft 1. The drive input shaft 1 connects the first shifting element SE1 to the planetary carrier PT1 of the first planetary gearset PR1. The first shifting element SE1 is also connected by the third shaft 3 to the sun gear S1 of the first planetary gearset PR1. The first shifting element SE1, made as a dual shifting element, is also connected by the fourth shaft 4 to the housing G. The ring gear H1 of the first planetary gearset PR1 is connected by the fifth shaft 5 to the sun gear S2 of the second planetary gearset PR2. The ring gear H2 of the second planetary gearset PR2 is connected by the sixth shaft 6 to the second shifting element SE2 made as a dual shifting element. The latter is also connected by the seventh shaft 7 to the housing G and on another side by the drive output shaft 2 to the planetary carrier PT2 of the second planetary gearset PR2, and further, to the transmission output AB. With the embodiment of the multi-speed transmission 9 just described four different transmission ratios can be obtained between the transmission input AN and the transmission output AB. The first gear can be obtained when the first shifting element SE1 connects the drive input shaft 1 to the third shaft 3 and at the same time the second shifting element SE2 connects the sixth shaft 6 to the seventh shaft 7, whereby the sixth shaft 6 can be braked or fixed relative to the housing G. The second gear can be obtained when the first shifting element SE1 connects the third shaft 3 to the fourth shaft 4 and thereby the third shaft 3 can be braked or fixed relative to the housing G. As in the first gear, the second shifting element SE2 connects the sixth shaft 6 and the seventh shaft 7 to one another. The third gear can be obtained when the first shifting element SE1 connects the drive input shaft 1 to the third shaft 3 and at the same time the second shifting element SE2 connects the sixth shaft 6 to the drive output shaft 2. The fourth gear can be obtained when the first shifting element SE1, as already in the second gear, connects the third shaft 3 to the fourth shaft 4 and the second shifting element SE2, as before in the third gear, connects the sixth shaft 6 to the drive output shaft 2.

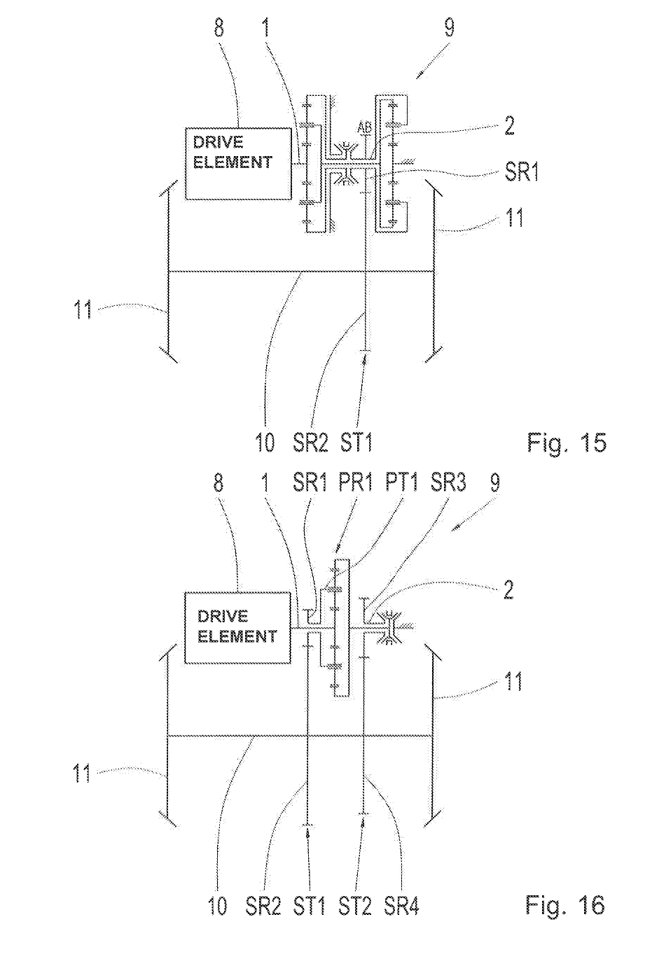

FIG. 15 shows a schematic representation of an arrangement of the first embodiment of a multi-speed transmission 9 according to the invention in a drive-train. By means of a drive element 8, rotational movement is imparted to the drive input shaft 1. This movement is introduced into the multi-speed transmission 9. At the transmission output AB there is arranged a first spur gear stage ST1. In this, a first spur gearwheel SG1 of the first spur gear stage ST1 is connected to the drive output shaft 2 of the multi-speed transmission 9. A second spur gearwheel SG2 of the first spur gear stage ST1 is connected to a vehicle axle 10. In this way the rotational movement introduced from the drive element 8 into the multi-speed transmission 9 and stepped up or stepped down by it can be transmitted to the vehicle axle 10 and thence to the wheels 11 connected to the axle. During this a further gear ratio is imposed by means of the first spur gear stage ST1.

FIG. 16 shows a schematic representation of a further arrangement of the first embodiment of the multi-speed transmission 9 according to the invention. In this case it has been possible to save the second planetary gearset PR2 by arranging a first spur gear stage ST1 on the planetary carrier PT1 of the first planetary gearset PR1. For this a first spur gearwheel SR1 is connected to the planetary carrier PT1 of the first planetary gearset PR1. This engages with a second spur gearwheel SR2, the second spur gearwheel SR2 being connected to the vehicle axle 10. Furthermore, a second spur gear stage ST2 is arranged on the known drive output shaft 2. A first spur gearwheel SR3 of the second spur gear stage ST2 is connected to the drive output shaft 2 and engages with a second spur gearwheel SR4. The second spur gearwheel SR4 of the second spur gear stage ST2 is also connected to the vehicle axle 10. In the embodiment shown here, in the same way two different transmission ratios can be obtained. For this, during driving operation an equilibrium in the multi-speed transmission 9 is produced between the drive output via the first spur gear transmission ST1 and the drive output via the second spur gear transmission ST2, whereby the vehicle axle 10 can be driven.

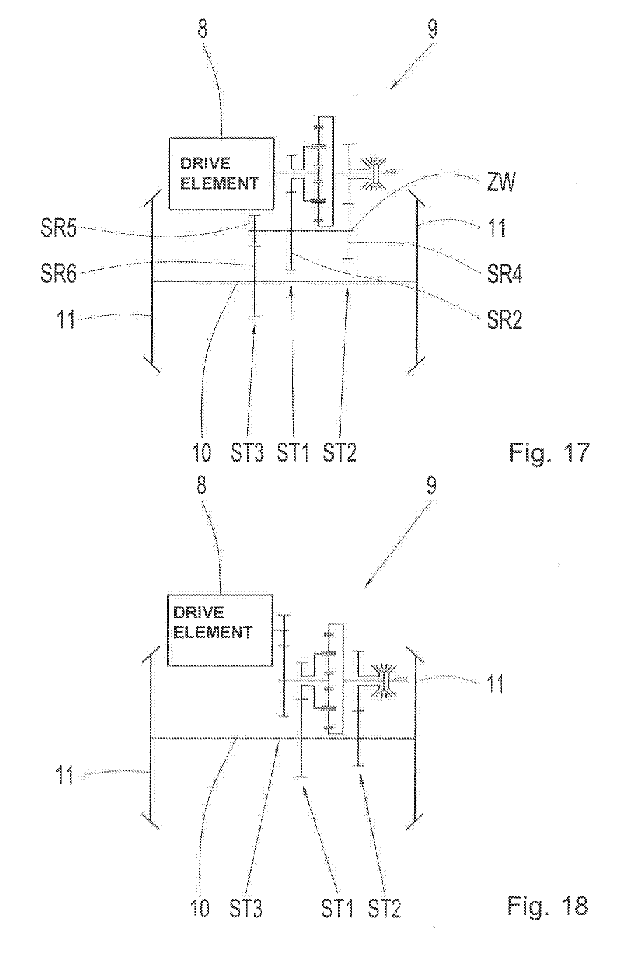

FIG. 17 shows a schematic representation of a further arrangement of the first embodiment of the multi-speed transmission 9 according to the invention. This differs from the embodiment shown in FIG. 16, in that the second spur gearwheel SR2 of the first spur gear stage ST1 and the second spur gearwheel SG4 of the second spur gear stage ST2 are not connected to the vehicle axle 10, but instead to an intermediate shaft ZW, the intermediate shaft ZW being further connected to a first spur gearwheel SR5 of a third spur gear stage ST3 whereas a second spur gearwheel SG6 of the third spur gear stage ST3 is connected to the vehicle axle 10. The vehicle axle 10 is also connected to wheels 11. Thus, by virtue of the third spur gear stage ST3, the rotational movement introduced from the drive element 8 into the multi-speed transmission 9 is stepped down some more.

FIG. 18 shows a schematic representation of another arrangement of the first embodiment of the multi-speed transmission 9 according to the invention. This differs from the arrangement shown in FIG. 16, in that a third spur gear stage ST3 is arranged between the drive element 8 and the multi-speed transmission 9. Thereby, already before the multi-speed transmission 9 the rotational movement is further stepped down or stepped up.

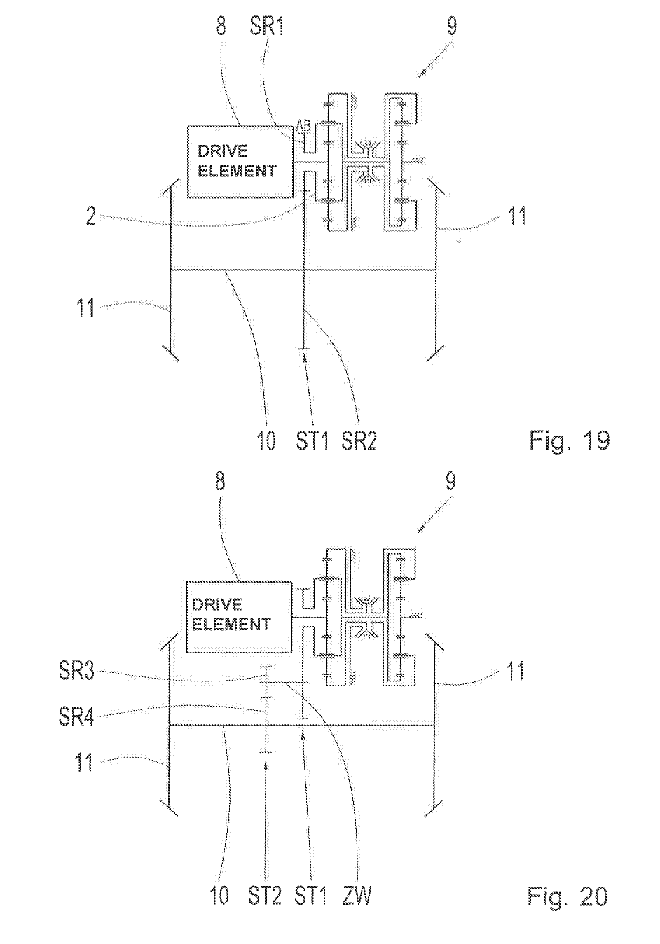

FIG. 19 shows a schematic representation of a further arrangement of the second embodiment of the multi-speed transmission 9 according to the invention. In this case a first spur gear stage ST1 is provided on the transmission output AB of the multi-speed transmission 9. The drive output shaft 2 of the multi-speed transmission 9 is connected to a first spur gearwheel SR1 of the first spur gear stage ST1. This first spur gearwheel SR1 engages with a second spur gearwheel SR2 of the first spur gear stage ST1 which is connected to the vehicle axle 10, whereby the vehicle axle 10 and the wheels connected thereto can be driven.

FIG. 20 shows a schematic representation of a further arrangement of the second embodiment of the multi-speed transmission 9 according to the invention. This differs from the arrangement shown in FIG. 19, in that the second spur gearwheel SG2 of the first spur gear stage ST1 is not connected to the vehicle axle 10 but to an intermediate shaft ZW, this intermediate shaft ZW also being connected to a first spur gearwheel SR3 of a second spur gear stage ST2. The gearwheel SR3, in turn, engages with a second spur gearwheel SR4 of the second spur gear stage ST2 which is connected to the vehicle axle 10. Thus, in contrast to the arrangement shown in FIG. 19, the second spur gear transmission ST2 provides a further gear ratio.

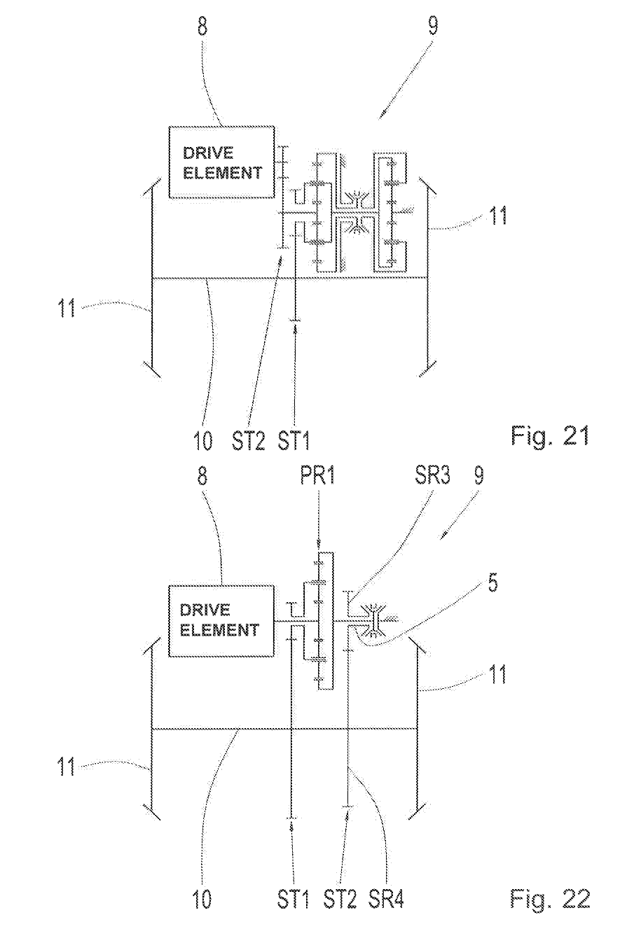

FIG. 21 shows a schematic representation of a further arrangement of the second embodiment of the multi-speed transmission 9 according to the invention. This differs from the arrangement shown in FIG. 19, in that a second spur gear stage ST2 is provided between the drive element 8 and the multi-speed transmission 9. Thus, already before the multi-speed transmission 9 the rotational speed is modified by a gear ratio.

FIG. 22 shows a schematic representation of a further arrangement of the second embodiment of the multi-speed transmission 9 according to the invention. In this case it has been possible to save the second planetary gearset PR2 by providing a second spur gear stage ST2 on the fifth shaft 5. Connected to the fifth shaft 5 there is a first spur gearwheel SR3 of the second spur gear stage ST2, which engages with a second spur gearwheel SR4 of the second spur gear stage ST2. Thus, the vehicle axle 10 is connected both to the first spur gear stage ST1 and also to the second spur gear stage ST2. During driving operation an equilibrium is established between the two spur gear stages ST1, ST2, whereby with this arrangement it is also possible to obtain two different transmission ratios.

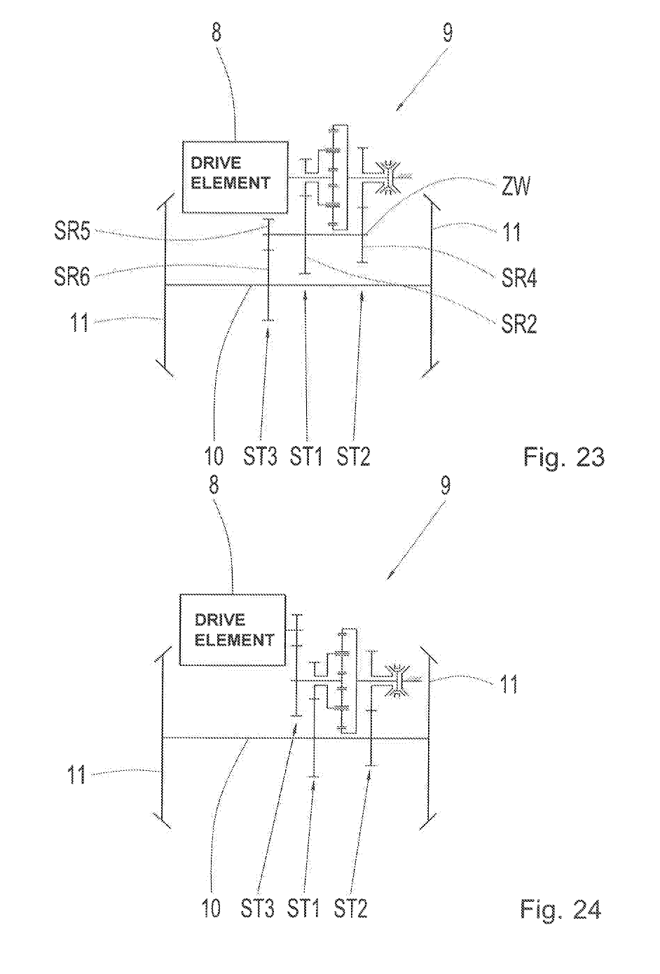

FIG. 23 shows a schematic representation of a further arrangement of the second embodiment of the multi-speed transmission 9 according to the invention. The arrangement shown here differs from the arrangement shown in FIG. 22, in that the respective second spur gearwheels SR2, SR4 of the first spur gear stage ST1 and the second spur gear stage ST2 are not connected to the vehicle axle 10, but to an intermediate shaft ZW and on the intermediate shaft ZW a third spur gear stage ST3 is provided, of which a first spur gearwheel SR5 is connected to the intermediate shaft ZW. The first spur gearwheel SR5 of the third spur gear stage ST3 engages with a second spur gearwheel SR6 of the third spur gear stage ST3 which is connected to the vehicle axle 10. Thus, compared with the arrangement shown in FIG. 22 a further transmission stage is provided between the multi-speed transmission 9 and the vehicle axle 10.

FIG. 24 shows a schematic representation of a further arrangement of the second embodiment of the multi-speed transmission 9 according to the invention. The arrangement shown in FIG. 24 differs from the arrangement shown in FIG. 22, in that in this case a third spur gear stage ST3 is provided between the drive element 8 and the multi-speed transmission 9.

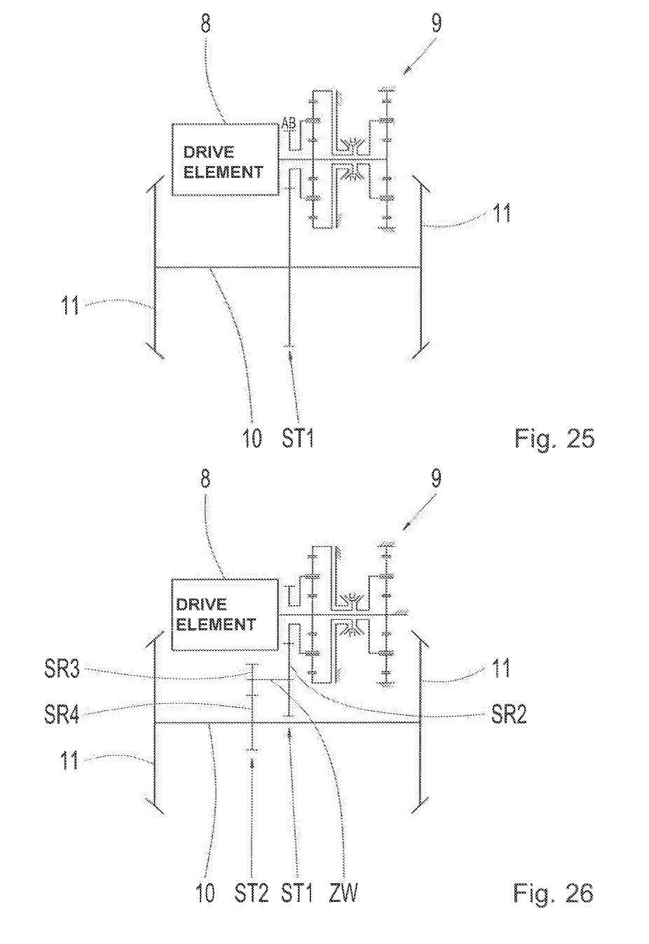

FIG. 25 shows a schematic representation of a further arrangement of the third embodiment of the multi-speed transmission 9 according to the invention. From the drive element 8 rotational movement is introduced into the multi-speed transmission 9. At the transmission output AB a first spur gear stage ST1 is provided, by which the rotational movement can be transmitted from the transmission output AB to the vehicle axle 10 and the wheels 11 connected thereto.

FIG. 26 shows a schematic representation of a further arrangement of the third embodiment of the multi-speed transmission 9 according to the invention. This differs from the arrangement shown in FIG. 25, in that a second spur gearwheel SR2 of the first spur gear stage ST1 is not connected as before to the vehicle axle 10, but instead to an intermediate shaft ZW to which is also connected a first spur gearwheel SR3 of a second spur gear stage ST2 which, further, engages with a second spur gearwheel SR4 of the second spur gear stage ST2. The second spur gearwheel SR4 of the second spur gear stage ST2 is also connected to the vehicle axle 10, whereby the rotational movement of the drive element 8 can be transmitted to the vehicle axle 10 and the wheels 11 connected thereto.

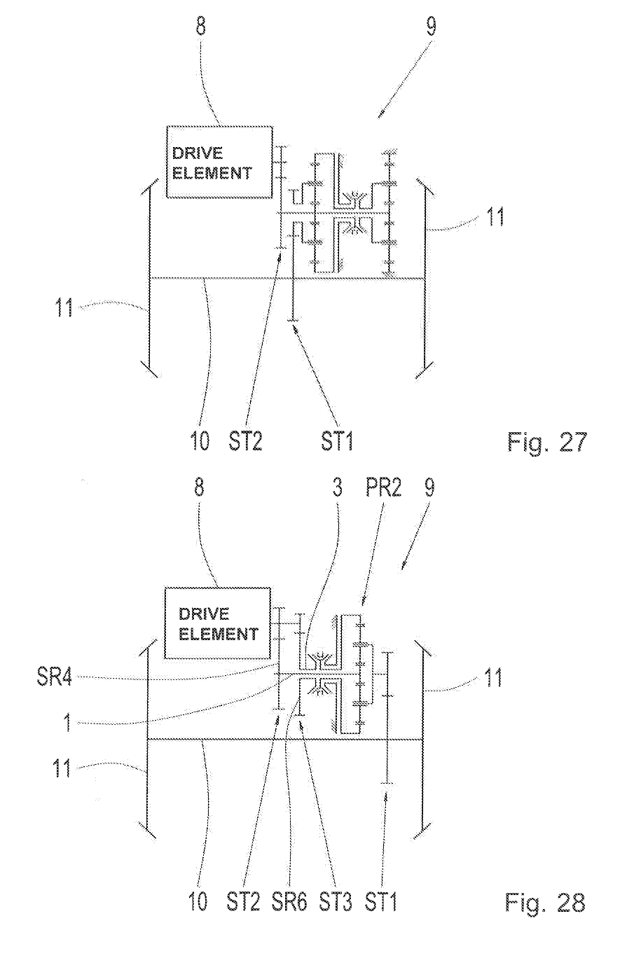

FIG. 27 shows a schematic representation of a further arrangement of the third embodiment of the multi-speed transmission 9 according to the invention. The arrangement shown here differs from the arrangement shown in FIG. 25, in that a second spur gear stage ST2 is provided between the drive element 8 and the multi-speed transmission 9. Thus, the rotational movement from the drive element 8 already undergoes a gear ratio modification before entering the multi-speed transmission 9.

FIG. 28 shows a schematic representation of a further arrangement of the third embodiment of the multi-speed transmission 9 according to the invention. In this case it has been possible to do without the first planetary gearset PR1 because between the drive element 8 and the multi-speed transmission 9 a second spur gear stage ST2 and a third spur gear stage ST3 have been provided. A second spur gearwheel SR4 of the second spur gear stage ST2 is connected to the drive input shaft 1 of the multi-speed transmission 9, whereas a second spur gearwheel SR6 of the third spur gear stage ST3 is connected to the third shaft 3 of the multi-speed transmission 9. During driving operation an equilibrium is established between the second spur gear stage ST2 and the third spur gear stage ST3. Thus, with this arrangement as well two different transmission ratios can be obtained between the drive element and the vehicle axle.

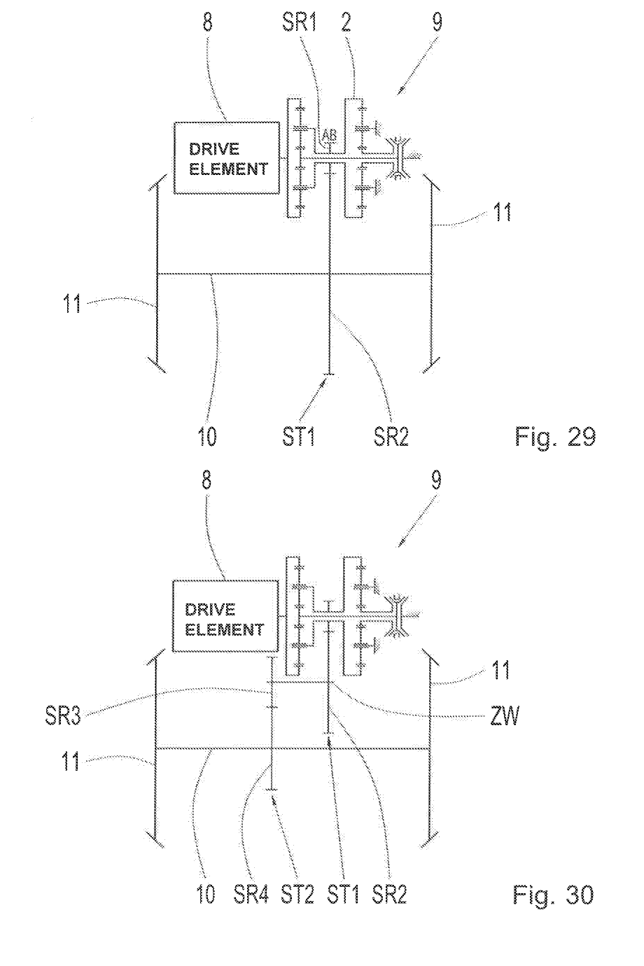

FIG. 29 shows a schematic representation of a further arrangement of the fourth embodiment of the multi-speed transmission 9 according to the invention. In this case the drive output shaft 2 is connected at the transmission output AB to a first spur gearwheel SR1 of a first spur gear stage ST1. The first spur gearwheel SR1 engages with a second spur gearwheel SR2 of the first spur gear stage ST1, and the second spur gearwheel SR2 is connected to the vehicle axle 10 so that thereby rotational movement produced by the drive element can be transmitted to the vehicle axle 10 and to the wheels 11 attached thereto.

FIG. 30 shows a schematic representation of a further arrangement of the fourth embodiment of the multi-speed transmission 9 according to the invention. In this case the arrangement shown here differs from the arrangement shown in FIG. 29 in that the second spur gearwheel SR2, instead of being connected to the vehicle axle 10, is connected to an intermediate shaft ZW, which is also connected to a first spur gearwheel SR3 of a second spur gear stage ST2. Engaged with the first spur gearwheel SR3 is a second spur gearwheel SR4 of the second spur gear stage ST2, and this second spur gearwheel SR4 is connected to the vehicle axle 10 and to the wheels 11 attached thereto.

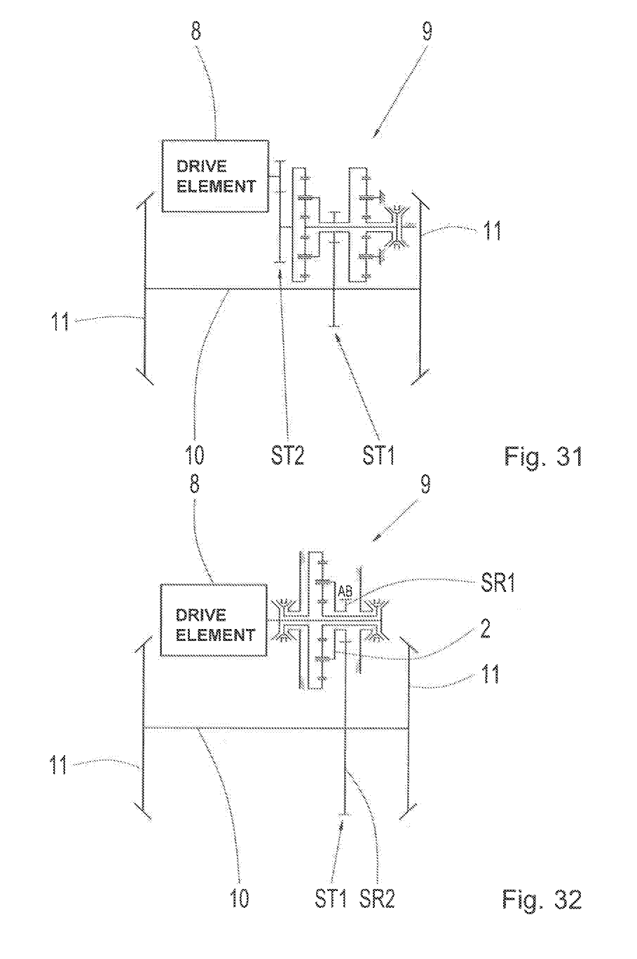

FIG. 31 shows a schematic representation of a further arrangement of the fourth embodiment of the multi-speed transmission 9 according to the invention. This differs from the arrangement shown in FIG. 29 in that a second spur gear stage ST2 is provided between the drive element 8 and the multi-speed transmission 9. Thus, the rotational movement produced by the drive element 8 already undergoes a gear ratio modification before it is introduced into the multi-speed transmission 9.

FIG. 32 shows a schematic representation of a further arrangement of the fifth embodiment of the multi-speed transmission 9 according to the invention. In this case the drive element 8 introduces rotational movement into the multi-speed transmission 9. At the transmission output a first spur gear stage ST1 is provided. The drive output shaft 2 is connected to a first spur gearwheel SR1 of the first spur gear stage ST1. The first spur gearwheel SR1 engages with a second spur gearwheel SR2 of the first spur gear stage ST1 which is connected to the vehicle axle 10. In this way the rotational movement of the drive element 8, as modified by the transmission ratio of the multi-speed transmission 9, can be transmitted to the vehicle axle 10.

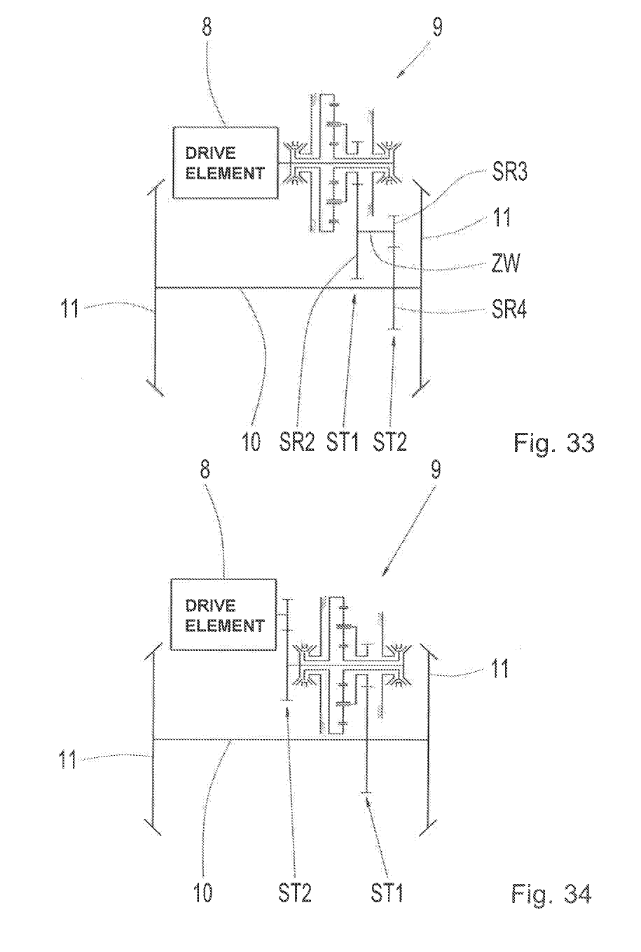

FIG. 33 shows a schematic representation of a further arrangement of the fifth embodiment of the multi-speed transmission 9 according to the invention. This differs from the arrangement shown in FIG. 32, in that instead of being connected to the vehicle axle 10, the second spur gearwheel SR2 of the first spur gear stage ST1 is connected to an intermediate shaft ZW which is in turn connected to a first spur gearwheel SR3 of a second spur gear stage ST2. The first spur gearwheel SR3 engages with a second gearwheel SR4 of the second spur gear stage ST2 which is connected to the vehicle axle 10. Thus, the rotational movement from the drive element 8 is modified by a further gear ratio of the second spur gear stage ST2.

FIG. 34 shows a schematic representation of a further arrangement of the fifth embodiment of the multi-speed transmission 9 according to the invention. This differs from the arrangement shown in FIG. 32, in that a second spur gear stage ST2 is provided between the drive element 8 and the multi-speed transmission 9. Thus, the rotational movement from the drive element 8 is already modified by a gear ratio before being introduced into the multi-speed transmission 9.

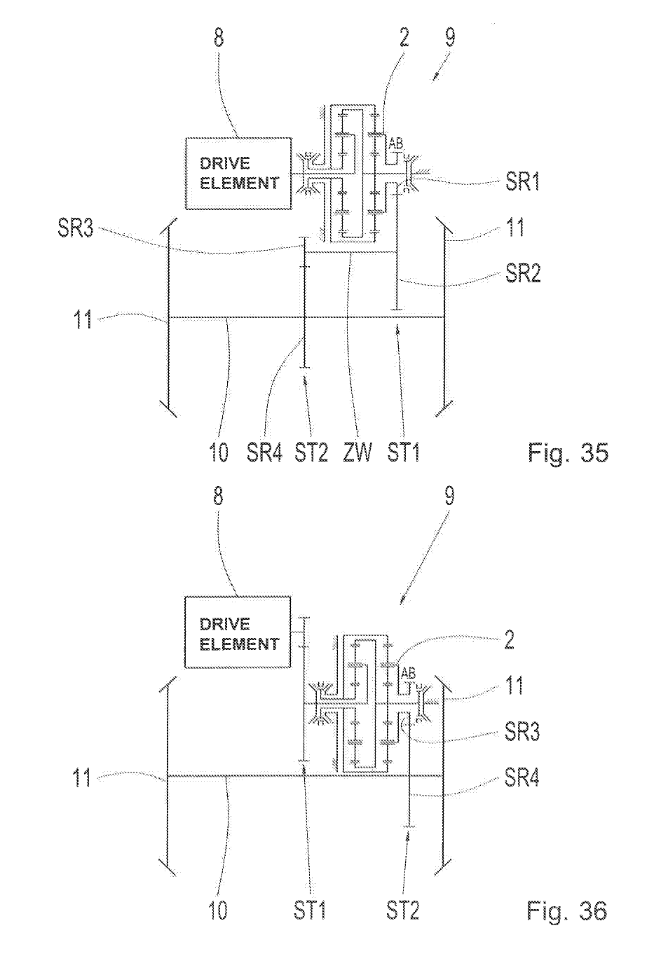

FIG. 35 shows a schematic representation of a further arrangement of the sixth embodiment of the multi-speed transmission 9 according to the invention. In this case rotational movement from the drive element 8 is introduced into the multi-speed transmission 9 and correspondingly modified. At the transmission output the drive output shaft 2 is connected to a first spur gearwheel SR1 of a first spur gear stage ST1. The first spur gearwheel SR1 engages with a second spur gearwheel SR2 of the first spur gear stage ST1 which is connected to an intermediate shaft ZW. Also connected to this intermediate shaft ZW is a first spur gearwheel SR3 of a second spur gear stage ST2. The first spur gearwheel SR3 engages with a second spur gearwheel SR4 of the second spur gear stage ST2. This second spur gearwheel SR4 is connected to the vehicle axle 10. Thus, the rotational movement of the drive element 8 is transmitted to the vehicle axle 10 and the wheels 11 attached thereto by way of the multi-speed transmission 9, the first spur gear stage ST1 and the second spur gear stage ST2.

FIG. 36 shows a schematic representation of a further arrangement of the sixth embodiment of the multi-speed transmission 9 according to the invention. This differs from the arrangement shown in FIG. 35, in that a first spur gear stage ST1 is provided between the drive element 8 and the multi-speed transmission 9. In that way the rotational movement from the drive element 8 already undergoes a ratio modification before being introduced into the multi-speed transmission 9. At the transmission output AB the drive output shaft 2 is connected to a first spur gearwheel SR3 of a second spur gear stage ST2. The first spur gearwheel SR3 engages with a second spur gearwheel SR4 of the second spur gear stage SR2 which is connected to the vehicle axle 10.

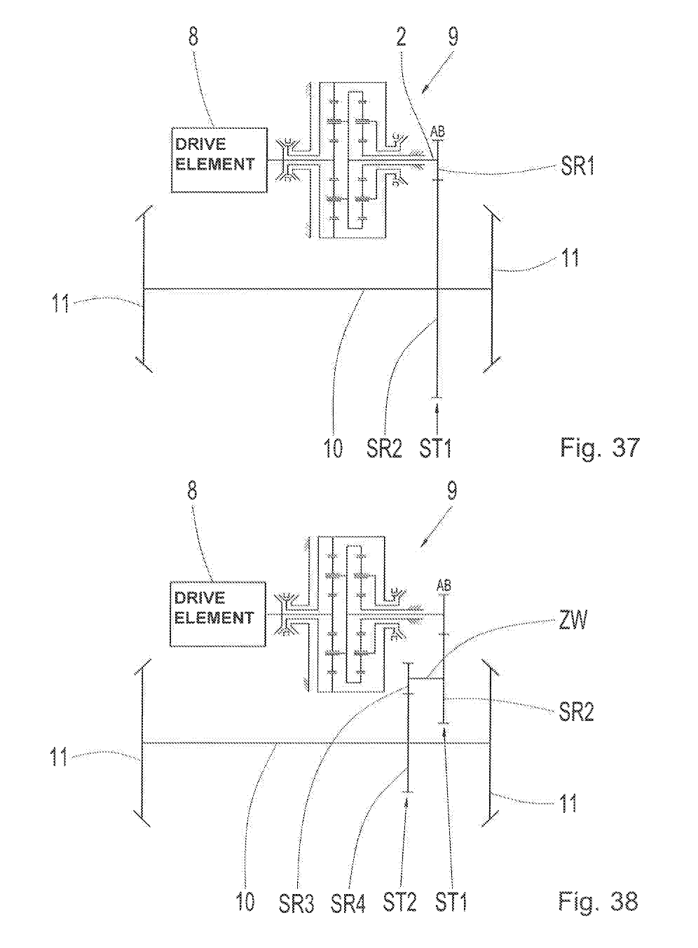

FIG. 37 shows a schematic representation of a further arrangement of the seventh embodiment of the multi-speed transmission 9 according to the invention. In this case rotational movement from the drive element 8 is introduced into the multi-speed transmission 9. At the transmission output AB of the multi-speed transmission 9 the drive output shaft 2 is connected with a first spur gearwheel SR1 of a first spur gear stage ST1. This first gearwheel SR1 engages with a second spur gearwheel SR2 of the first spur gear stage ST1 which is connected to the vehicle axle 10. The rotational movement undergoes a corresponding ratio change by the multi-speed transmission 9 and the spur gear stage ST1, and is transmitted to the vehicle axle 10 and the wheels 11 attached thereto.

FIG. 38 shows a schematic representation of a further arrangement of the seventh embodiment of the multi-speed transmission 9 according to the invention. The arrangement shown in this case differs from the arrangement shown in FIG. 37, in that the second spur gearwheel SR2 of the first spur gear stage ST1 is not connected to the vehicle axle 10, but instead to an intermediate shaft ZW. Also connected to the intermediate shaft ZW is a first spur gearwheel SR3 of a second spur gear stage ST2, while a second spur gearwheel SR4 of the second spur gear stage ST2 is connected to the vehicle axle 10. Thus, compared with the arrangement shown in FIG. 37, in this case a further step-down or step-up of the rotational movement takes place between the multi-speed transmission 9 and the vehicle axle 10.

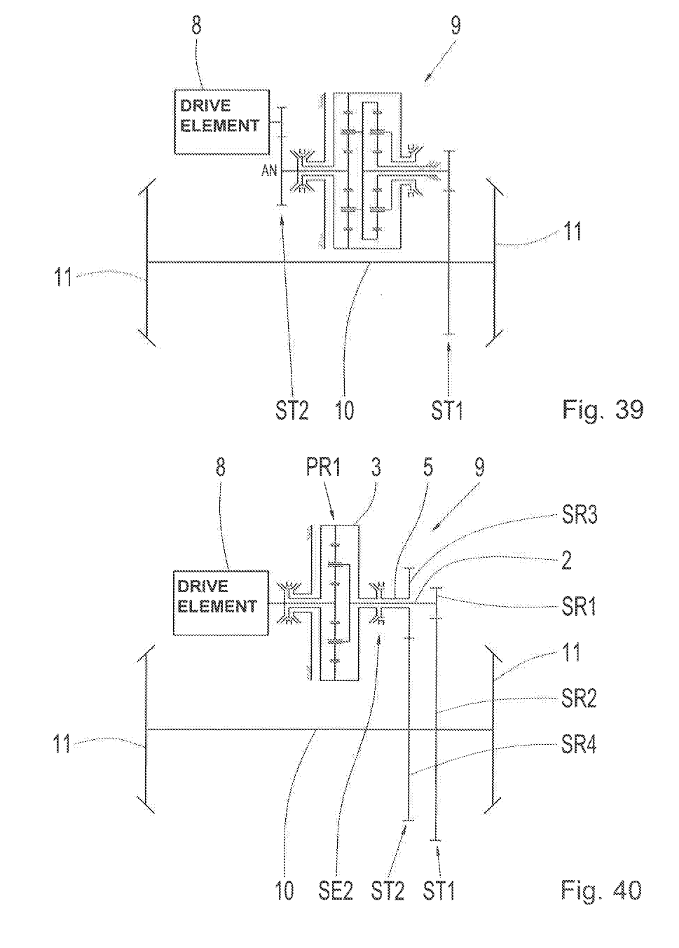

FIG. 39 shows a schematic representation of a further arrangement of the seventh embodiment of the multi-speed transmission 9 according to the invention. This differs from the arrangement shown in FIG. 37, in that a second spur gear stage ST2 is arranged between the drive element 8 and the multi-speed transmission 9. Thus, already on the input side AN of the multi-speed transmission the rotational movement undergoes a ratio modification by the second spur gear stage ST2 before the rotational movement is introduced into the multi-speed transmission 9.

FIG. 40 shows a schematic representation of a further arrangement of the seventh embodiment of the multi-speed transmission 9 according to the invention. In this case the design omits the second planetary gearset PR2 because although the third shaft 3 can still be connected by the second shifting element SE2 to the fifth shaft 5, now however, instead of being connected to the planetary carrier PT2 of the second planetary gearset PR2 the fifth shaft 5 is connected to a first spur gearwheel SR3 of a second spur gear stage ST2. This first spur gearwheel SR3 engages with a second spur gearwheel SR4 of the second spur gear stage ST2 which is connected to the vehicle axle 10. The drive output shaft 2 now only connects the planetary carrier PT1 of a first planetary gearset PR1 to a first spur gearwheel SR1 of a first spur gear stage ST1, which gearwheel SR1 engages with a second spur gear SR2 of the first spur gear stage. The second spur gearwheel SR2 of the first spur gear stage ST1 is also connected to the vehicle axle 10. By virtue of the arrangement of the first spur gear stage ST1 and the second spur gear stage ST2, during driving operation an equilibrium is established in the multi-speed transmission 9, and for that reason, in this arrangement which omits the second planetary gearset PR2, again three different transmission ratios can be obtained between the drive element 8 and the vehicle axle 10.

FIG. 41 shows a schematic representation of a further arrangement of the seventh embodiment of the multi-speed transmission 9 according to the invention. This differs from the embodiment shown in FIG. 40, in that instead of being connected to the vehicle axle 10, the second spur gearwheel SR2 of the first spur gear stage ST1 and the second spur gearwheel SR4 of the second spur gear stage ST2 are connected to an intermediate shaft ZW. In turn the intermediate shaft ZW is connected to a first spur gearwheel SR5 of a third spur gear stage ST3. Engaging with the first spur gearwheel SR5 is a second spur gearwheel SR6 of the third spur gear stage ST3, and this second spur gearwheel SR6 is connected to the vehicle axle 10. Thus, compared with the arrangement shown in FIG. 40, a further gear ratio modification takes place between the multi-speed transmission 9 and the vehicle axle 10 by virtue of the third spur gear stage ST3.

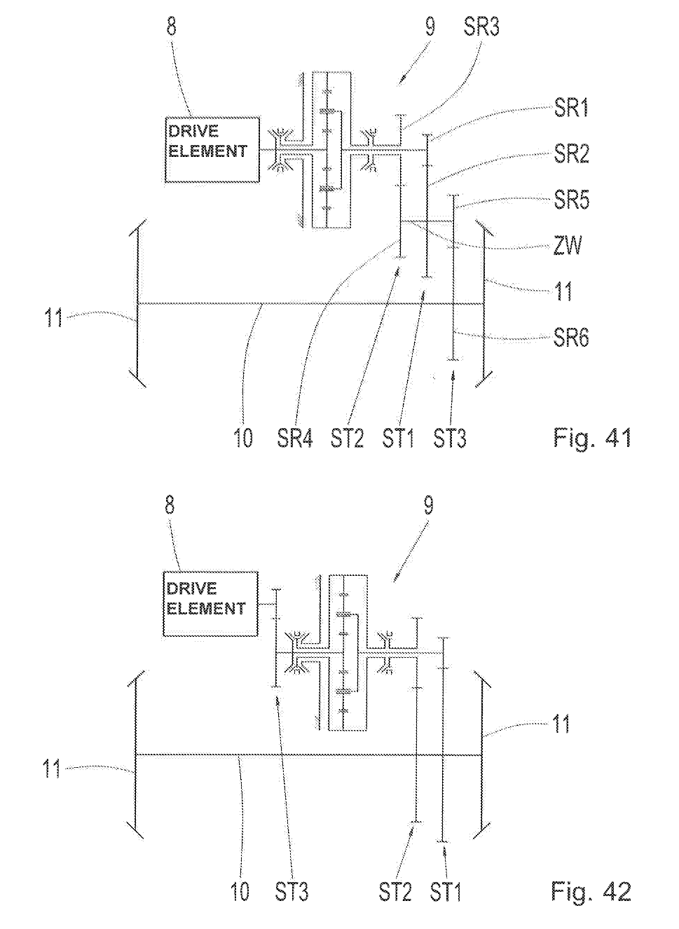

FIG. 42 shows a schematic representation of a further arrangement of the seventh embodiment of the multi-speed transmission 9 according to the invention. This differs from the arrangement shown in FIG. 40 in that in the present arrangement, a third spur gear stage ST3 is provided between the drive element 8 and the multi-speed transmission 9. Thus, by virtue of this third spur gear stage ST3 the rotational movement introduced by the drive element 8 undergoes a ratio modification before it is introduced into the multi-speed transmission 9.

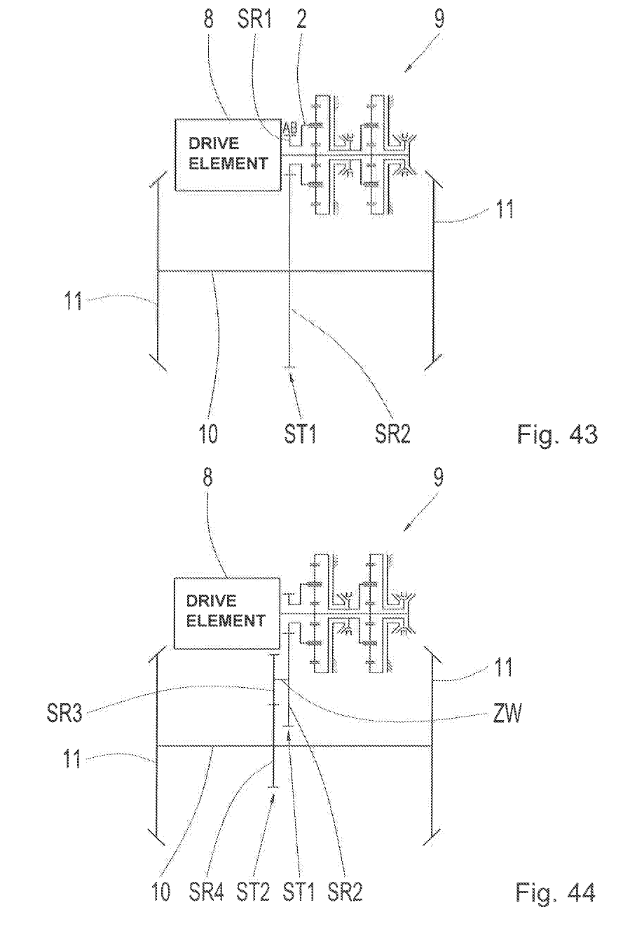

FIG. 43 shows a schematic representation of a further arrangement of the eighth embodiment of the multi-speed transmission 9 according to the invention. The drive element 8 introduces rotational movement into the multi-speed transmission 9. At the transmission output AB the drive output shaft 2 is connected to a first spur gearwheel SR1 of a first spur gear stage ST1. The first spur gearwheel SR1 engages with a second spur gearwheel SR2 of the first spur gear stage ST1, whereas the second spur gearwheel SR2 is connected to the vehicle axle 10 and thus transmits rotational movement to the vehicle axle 10 and the wheels 11 attached thereto.

FIG. 44 shows a schematic representation of a further arrangement of the eighth embodiment of the multi-speed transmission 9 according to the invention. The arrangement shown here differs from the arrangement shown in FIG. 43, in that instead of being connected to the vehicle axle 10, the second spur gearwheel SR2 of the first spur gear stage ST1 is connected to an intermediate shaft ZW, to which a first spur gearwheel SR3 of a second spur gear stage ST2 is also connected. Engaged with the first spur gearwheel SR3 is a second spur gearwheel SR4 of the second spur gear stage ST2, and this second spur gearwheel SR4 is connected to the vehicle axle 10. Thus, in contrast to the embodiment shown in FIG. 43, by virtue of the arrangement of the second spur gear stage ST2 a further ratio modification takes place between the multi-speed transmission 9 and the vehicle axle 10.

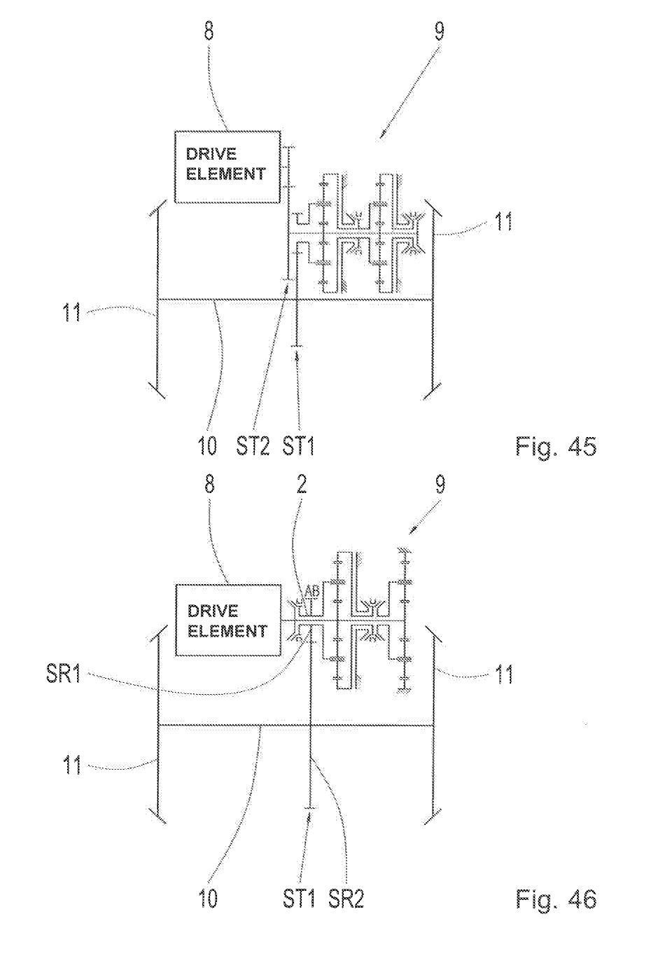

FIG. 45 shows a schematic representation of a further arrangement of the eighth embodiment of the multi-speed transmission 9 according to the invention. This differs from the embodiment shown in FIG. 43, in that a second spur gear stage ST2 is provided between the drive element 8 and the multi-speed transmission 9. This means that the rotational movement of the drive element 8 undergoes a ratio modification before it is introduced into the multi-speed transmission 9.

FIG. 46 shows a schematic representation of a further arrangement of the ninth embodiment of the multi-speed transmission 9 according to the invention. From the drive element 8 rotational movement is introduced into the multi-speed transmission 9. At the transmission output AB the drive output shaft 2 is connected to a first spur gearwheel SR1 of a first spur gear stage ST1. The first spur gearwheel SR1 engages with a second spur gearwheel SR2 of the first spur gear stage ST1, which gearwheel SR2 is also connected to the vehicle axle 10. This enables the rotational movement produced by the drive element 8 to be transmitted to the vehicle axle 10 and the wheels 11 attached thereto.

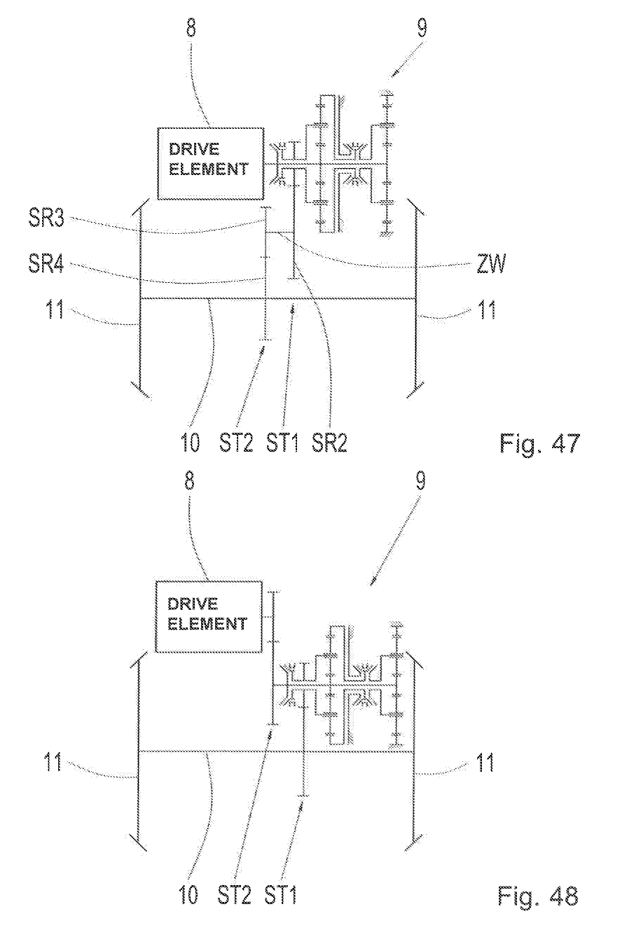

FIG. 47 shows a schematic representation of a further arrangement of the ninth embodiment of the multi-speed transmission 9 according to the invention. This differs from the arrangement shown in FIG. 46, in that instead of being connected to the vehicle axle, the second spur gearwheel SR2 of the first spur gear stage ST1 is connected to an intermediate shaft ZW. The intermediate shaft ZW is, further, connected to a first spur gearwheel SR3 of a second spur gear stage ST2 and engages with a second spur gearwheel SR4 of the second spur gear stage ST2. The second spur gearwheel SR4 of the second spur gear stage ST2 is connected to the vehicle axle 10. Thus, the arrangement shown here differs from the arrangement shown in FIG. 46, in that between the multi-speed transmission 9 and the vehicle axle 10, owing to the arrangement of the second spur gear stage the rotational movement produced by the drive element 8 undergoes a further gear ratio modification.

FIG. 48 shows a schematic representation of a further arrangement of the ninth embodiment of the multi-speed transmission 9 according to the invention. This differs from the arrangement shown in FIG. 46, in that a second spur gear stage ST2 is positioned between the drive element 8 and the multi-speed transmission 9. Thus, already before the rotational movement is introduced into the multi-speed transmission 9, it undergoes a gear ratio modification.

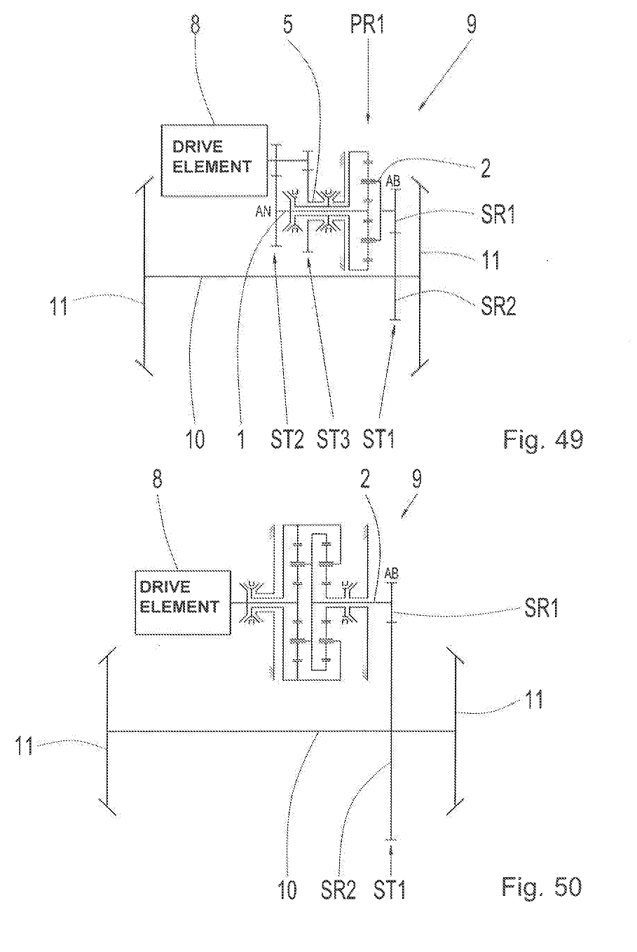

FIG. 49 shows a schematic representation of a further arrangement of the ninth embodiment of the multi-speed transmission 9 according to the invention. This differs from the embodiment shown in FIG. 46, in that rotational movement of the drive element 8 is transmitted by way of a second spur gear stage ST2 to the drive input shaft 1 and at the same time, by way of a third spur gear stage ST3, to the fifth shaft 5. The result of this arrangement is that the second planetary gearset PR2 can be omitted. Thanks to the arrangement described, during driving operation an equilibrium is established in the multi-speed transmission 9 and for that reason this arrangement too enables three different transmission ratios to be obtained. Furthermore, the transmission output AB is now on a side of the multi-speed transmission 9 opposite to the transmission input AN. At the transmission output AB the rotational movement is transmitted to the vehicle axle 10 by way of the first spur gear stage ST1.

FIG. 50 shows a schematic representation of a further arrangement of the tenth embodiment of the multi-speed transmission 9 according to the invention. The drive element 8 introduces rotational movement into the multi-speed transmission 9. At the transmission output AB the drive output shaft 2 is connected to a first spur gearwheel SR1 of a first spur gear stage ST1 and engages with a second spur gearwheel SR2 of the first spur gear stage ST1. The second spur gearwheel SR2 is also connected to the vehicle axle 10. By means of the multi-speed transmission 9 and the first spur gear stage ST1 rotational movement of the drive element can be transmitted to the vehicle axle 10 and the wheels 11 attached thereto in accordance with the respective transmission ratios.

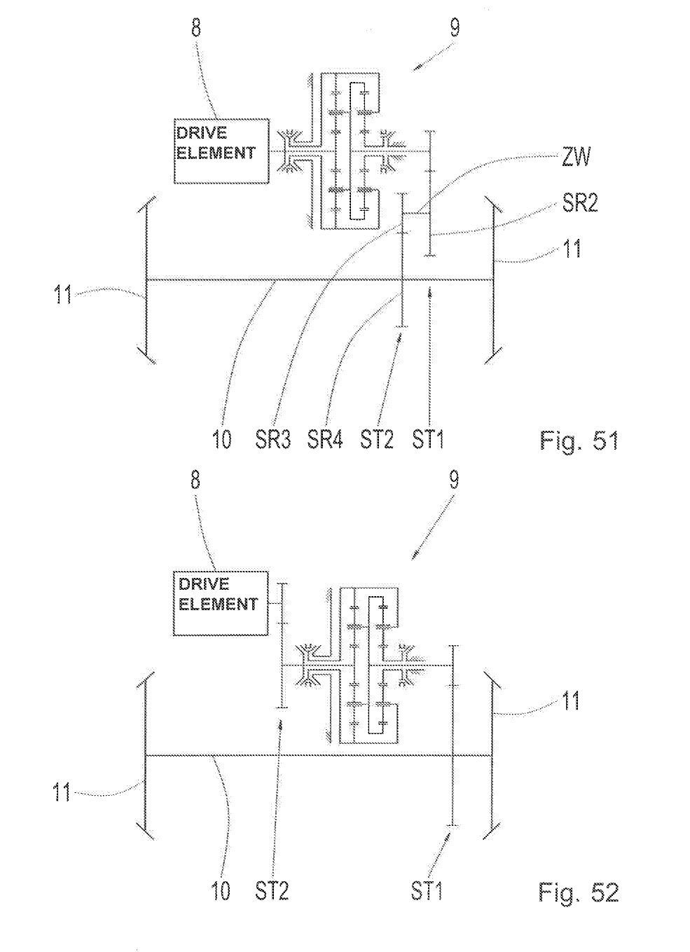

FIG. 51 shows a schematic representation of a further arrangement of the tenth embodiment of the multi-speed transmission 9 according to the invention. This differs from the arrangement shown in FIG. 50, in that instead of being connected to the vehicle axle 10, the second spur gearwheel SR2 of the first spur gear stage ST1 is connected to an intermediate shaft ZW which, in turn, is also connected to a first spur gearwheel SR3 of a second spur gear stage ST2. The first spur gearwheel SR3 engages with a second spur gearwheel SR4 of the second spur gear stage ST2, and this second spur gearwheel SR4 is connected to the vehicle axle 10. Thus, compared with the arrangement shown in FIG. 50, a second spur gear stage ST2 with a corresponding gear ratio is arranged between the multi-speed transmission 9 and the vehicle axle 10.

FIG. 52 shows a schematic representation of a further arrangement of the tenth embodiment of the multi-speed transmission 9 according to the invention. This differs from the embodiment shown in FIG. 50, in that a second spur gear stage ST2 is arranged between the drive element 8 and the multi-speed transmission 9. Accordingly, the rotational movement produced by the drive element 8 undergoes a first gear ratio modification before being introduced into the multi-speed transmission 9. By way of the first spur gear stage ST1 the rotational movement from the multi-speed transmission 9 is transmitted to the vehicle axle 10 and the wheels 11 attached thereto.

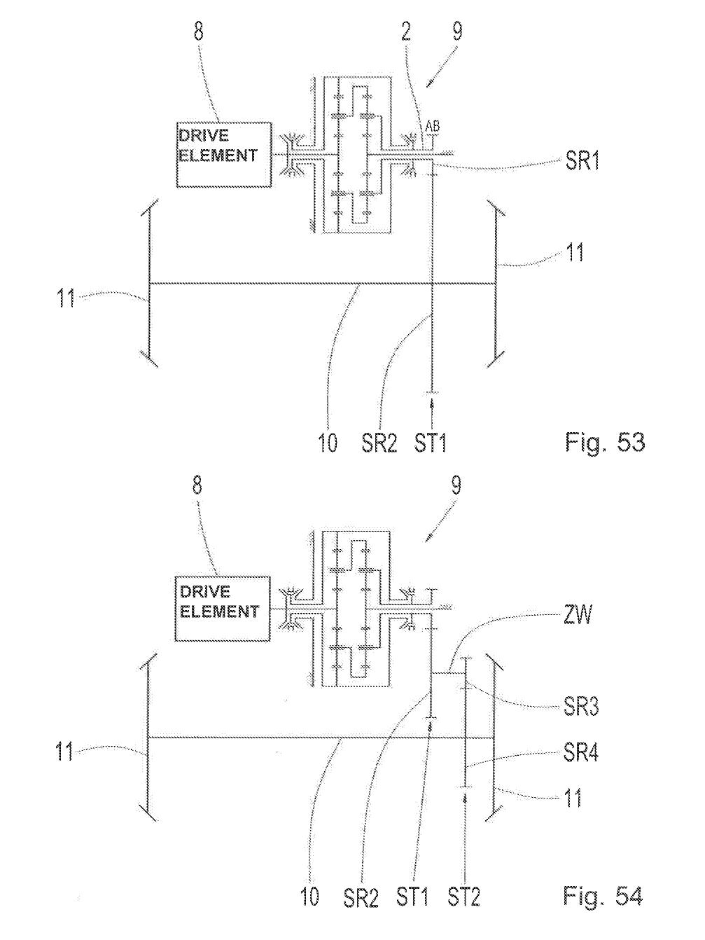

FIG. 53 shows a schematic representation of a further arrangement of the eleventh embodiment of the multi-speed transmission 9 according to the invention. In this, rotational movement from the drive element 8 is introduced into the multi-speed transmission 9 and undergoes a corresponding transmission ratio modification. At the transmission output AB the drive output shaft 2 is connected to a first spur gearwheel SR1 of a first spur gear stage ST1, and this first spur gearwheel SR1 engages with a second spur gearwheel SR2 of the first spur gear stage ST1. The second spur gearwheel SR2 of the first spur gear stage ST1 is connected to the vehicle axle 10, so that the rotational movement produced by the drive element 8 can be transmitted by way of the multi-speed transmission 9 and the first spur gear stage ST1 to the vehicle axle 10 and the wheels 11 attached thereto.

FIG. 54 shows a schematic representation of a further arrangement of the eleventh embodiment of the multi-speed transmission 9 according to the invention. The embodiment shown here differs from the embodiment shown in FIG. 53, in that instead of being connected to the vehicle axle 10, the second spur gearwheel SR2 of the first spur gear stage ST1 is now connected to an intermediate shaft ZW and that shaft is, further, connected to a first spur gearwheel SR3 of a second spur gear stage SR2. The first spur gearwheel SR3 engages with a second spur gearwheel of the second spur gear stage ST2. The second spur gearwheel SR4 is also connected to the vehicle axle 10. Thus, in contrast to the arrangement shown in FIG. 53, a further transmission ratio modification is provided by the second spur gear stage SR2. The rotational movement from the drive element 8 can therefore be transmitted to the vehicle axle 10 and the wheels 11 attached thereto by way of the multi-speed transmission 9, the first spur gear stage ST1 and the second spur gear stage ST2.

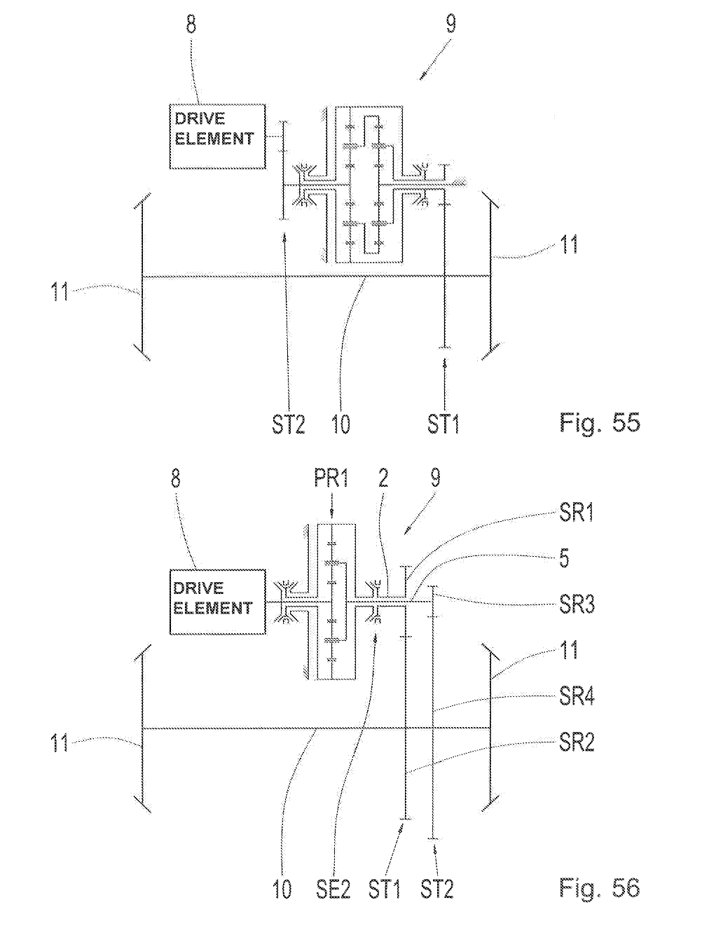

FIG. 55 shows a schematic representation of a further arrangement of the eleventh embodiment of the multi-speed transmission 9 according to the invention. This differs from the arrangement shown in FIG. 53, in that a second spur gear stage ST2 is provided between the drive element 8 and the multi-speed transmission 9. Consequently, the rotational movement from the drive element 8 already undergoes a gear ratio modification before being introduced into the multi-speed transmission 9.

FIG. 56 shows a schematic representation of a further arrangement of the eleventh embodiment of the multi-speed transmission 9 according to the invention. This arrangement of the multi-speed transmission 9 comprises only a first planetary gearset PR1. It has been possible to omit the second planetary gearset PR2 because the planetary carrier PT1 of the first planetary gearset PR1 is connected by way of the fifth shaft 5 to a first spur gearwheel SR3 of a second spur gear stage ST2, while the spur gearwheel SR3 engages with a second spur gearwheel SR4 of the second spur gear stage ST2, which is connected to the vehicle axle 10. As in previous cases the drive output shaft 2 is connected to the first spur gearwheel SR1 of the first spur gear transmission and this first spur gearwheel SR1 engages with the second spur gearwheel SR2, which is also connected to the vehicle axle 10. Owing to the arrangement of the spur gear transmissions ST1, ST2, during driving operation an equilibrium is established in the multi-speed transmission 9 whereby, again, three different transmission ratios can be obtained between the drive element 8 and the vehicle axle 10 and the wheels 11 attached thereto.

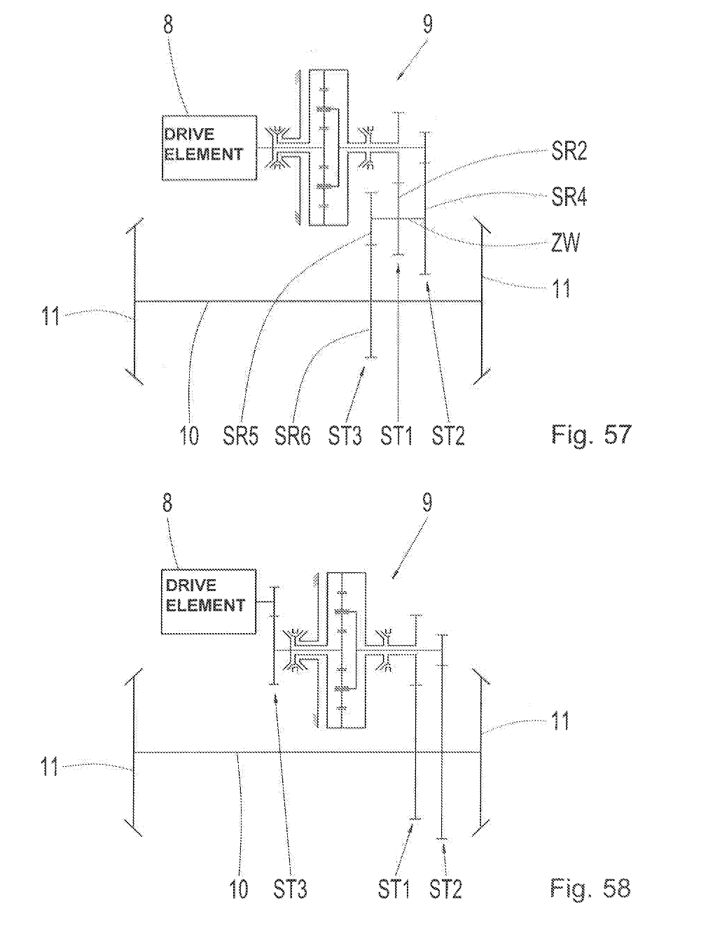

FIG. 57 shows a schematic representation of a further arrangement of the eleventh embodiment of the multi-speed transmission 9 according to the invention. The arrangement in FIG. 57 differs from the arrangement shown in FIG. 56, in that the second spur gearwheels SR2, SR4 of the two spur gear stages ST1, ST2, instead of being connected to the vehicle axle 10, are connected to an intermediate shaft ZW. With the latter is also connected a first spur gearwheel SR5 of a third spur gear stage ST3 and this first spur gearwheel SR5 engages with a second spur gearwheel SR6 of the third spur gear stage ST3 and is also connected to the vehicle axle 10. Thus, the arrangement shown here differs from the arrangement shown in FIG. 56, in that by virtue of the third spur gear stage ST3 a further gear ratio is provided between the multi-speed transmission 9 and the vehicle axle 10.

FIG. 58 shows a schematic representation of a further arrangement of the eleventh embodiment of the multi-speed transmission 9 according to the invention. The arrangement shown here differs from the arrangement shown in FIG. 56, in that a third spur gear stage ST3 is arranged between the drive element 8 and the multi-speed transmission 9. This has the result that the rotational movement produced by the drive element 8 already undergoes a transmission ratio modification before being introduced into the multi-speed transmission 9.

FIG. 59 shows a schematic representation of a further arrangement of the twelfth embodiment of the multi-speed transmission 9 according to the invention. Rotational movement produced by the drive element 8 is introduced into the multi-speed transmission 9. At the transmission output AB the drive output shaft 2 is connected to a first spur gearwheel SR1 of a first spur gear stage ST1. The first spur gearwheel SR1 engages with a second spur gearwheel SR2 of the first spur gear stage ST1 which is connected to the vehicle axle 10. By virtue of the multi-speed transmission 9 and the first spur gear transmission ST1 the rotational movement produced by the drive element 8 can be transmitted to the vehicle axle 10 and the wheels 11 attached thereto after conversion in accordance with the two respective transmission ratios.

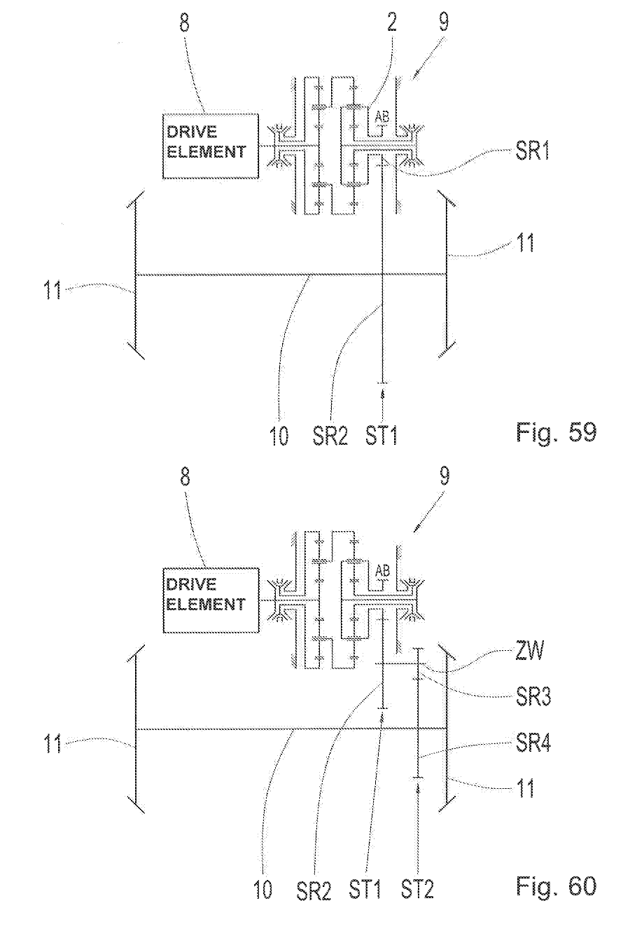

FIG. 60 shows a schematic representation of a further arrangement of the twelfth embodiment of the multi-speed transmission 9 according to the invention. The arrangement shown here differs in relation to the arrangement shown in FIG. 59, in that instead of being connected to the vehicle axle 10, the second spur gearwheel SR2 of the first spur gear stage ST1 is connected to an intermediate shaft ZW which in turn is connected to a first spur gearwheel SR3 of a second spur gear stage ST2. The first spur gearwheel SR3 engages with a second spur gearwheel SR4 of the second spur gear stage ST2 which is connected to the vehicle axle 10. Accordingly, in contrast to the arrangement shown in FIG. 59 a further ratio modification of the rotational movement provided by the drive element is interposed by the second spur gear stage SR2 between the multi-speed transmission 9 and the vehicle axle 10.

FIG. 61 shows a schematic representation of a further arrangement of the twelfth embodiment of the multi-speed transmission 9 according to the invention. This differs from the arrangement shown in FIG. 59, in that a second spur gear stage ST2 is arranged between the drive element 8 and the multi-speed transmission 9. Consequently, the rotational movement produced by the drive element 8 undergoes a first ratio modification before being introduced into the multi-speed transmission 9.

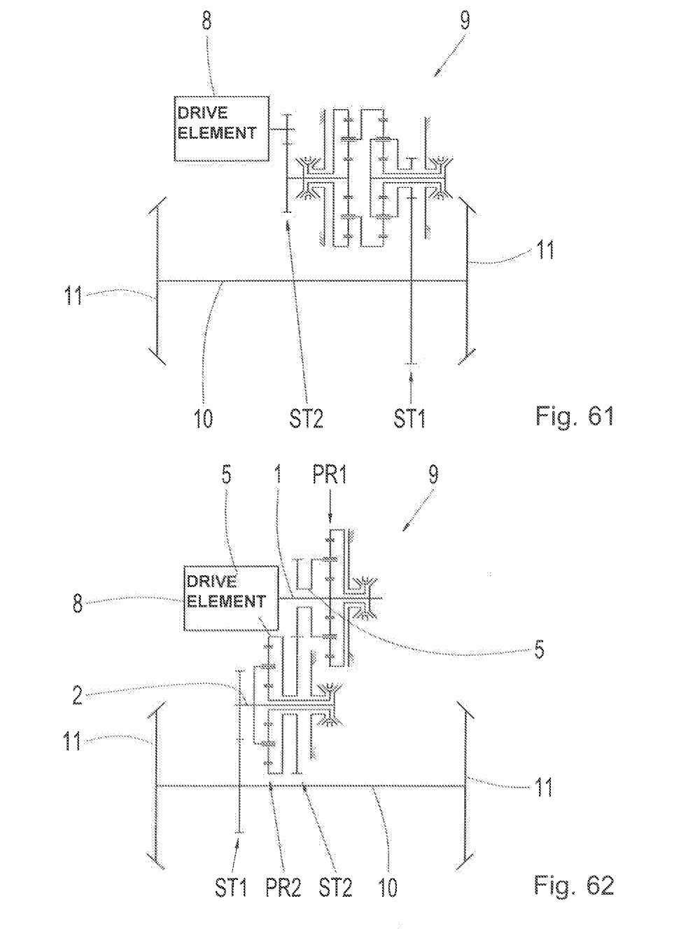

FIG. 62 shows a schematic representation of a further arrangement of the twelfth embodiment of the multi-speed transmission 9 according to the invention. The arrangement shown here differs from the arrangement shown in FIG. 59, in that the fifth shaft, which connects the planetary carrier PT1 of the first planetary gearset PR1 to the ring gear H2 of the second planetary gearset PR2, is interrupted by a second spur gear stage ST2. The result is that the drive input shaft 1 and the drive output shaft 2 are parallel to one another. A further consequence is that the respective rotational axes of the first planetary gearset PR1 and the second planetary gearset PR2 are also axially offset relative to one another.

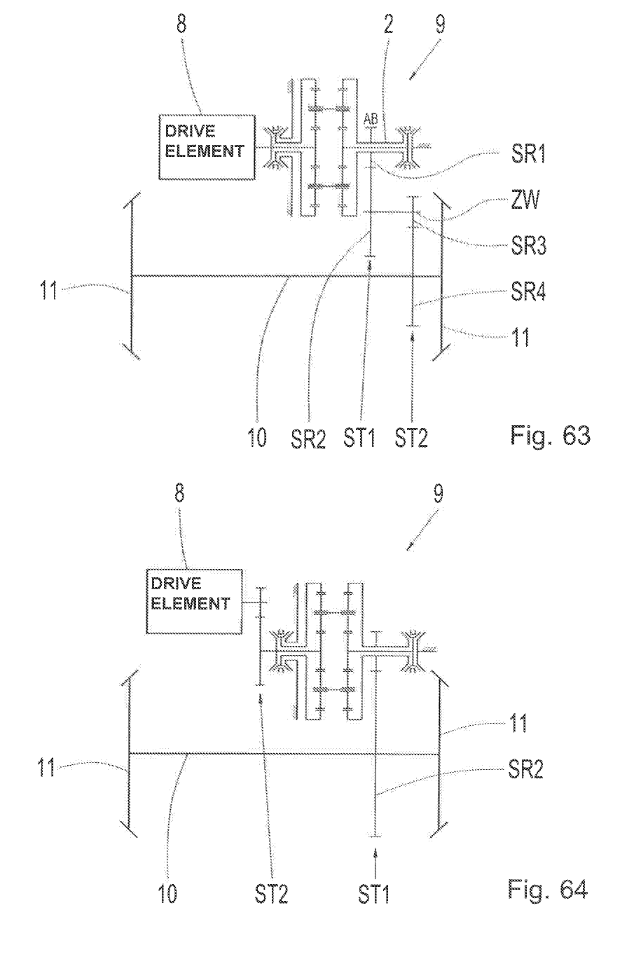

FIG. 63 shows a schematic representation of a further arrangement of the thirteenth embodiment of the multi-speed transmission 9 according to the invention. Rotational movement from the drive element 8 is introduced into the multi-speed transmission 9. At the transmission output AB the drive output shaft 2 is connected, among other things, to a first spur gearwheel SR1 of a first spur gear stage ST1. The first spur gearwheel SR1 engages with a second spur gearwheel SR2 of the first spur gear stage ST1 which is connected to an intermediate shaft ZW. The latter is, further, connected to a first spur gearwheel SR3 of a second spur gear stage ST2, which engages with a second spur gearwheel SR4 of the second spur gear stage ST2. The second spur gearwheel SR4 of the second spur gear transmission ST2 is connected to the vehicle axle 10. Thus, the rotational movement produced by the drive element 8 is transmitted to the vehicle axle 10 and the wheels 11 attached thereto by way of the multi-speed transmission 9 and the two spur gear transmissions ST1, ST2, having regard to their respective transmission ratios.

FIG. 64 shows a schematic representation of a further arrangement of the thirteenth embodiment of the multi-speed transmission 9 according to the invention. This differs from the arrangement shown in FIG. 63, in that the second spur gear stage ST2 is arranged between the drive element 8 and the multi-speed transmission 9. This means that the rotational movement produced by the drive element 8 already undergoes a ratio modification before it is introduced into the multi-speed transmission 9. A further difference from the arrangement shown in FIG. 63 is that there is no intermediate shaft ZW, so that instead of being connected to the intermediate shaft ZW, the second spur gearwheel SR2 of the first spur gear stage ST1 is consequently connected to the vehicle axle 10.

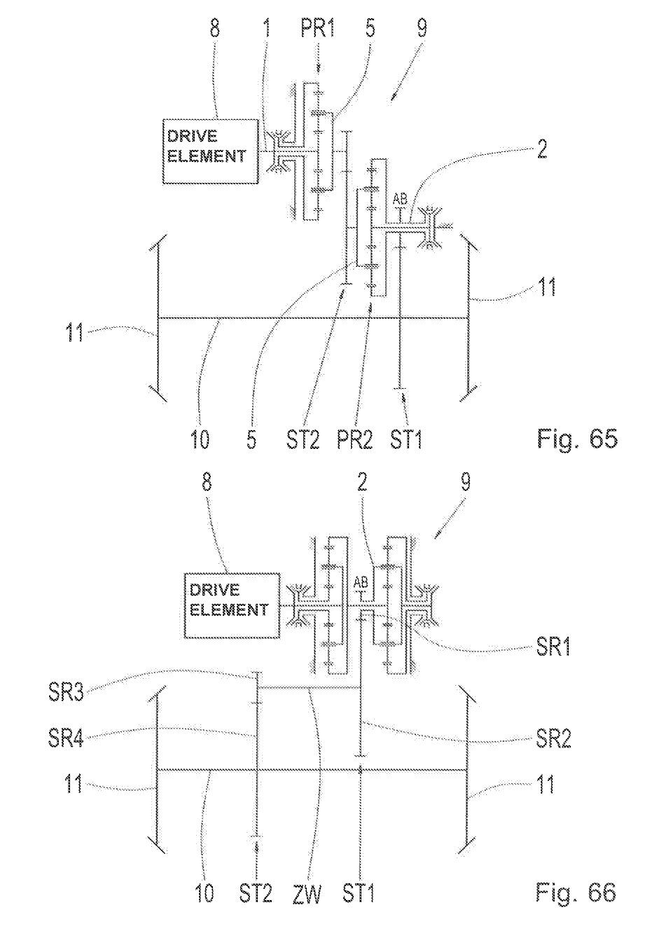

FIG. 65 shows a schematic representation of a further arrangement of the thirteenth embodiment of the multi-speed transmission 9 according to the invention. The arrangement shown here differs from the arrangement shown in FIG. 64, in that the drive element 8 is connected directly to the drive input shaft 1. Furthermore, instead of being arranged between the drive element 8 and the drive input shaft 1, the second spur gear stage ST2 is now arranged between the first planetary gearset PR1 and the second planetary gearset PR2. In this case the fifth shaft 5, which connects the planetary carrier PT1 of the first planetary gearset PR1 to the planetary carrier PT2 of the second planetary gearset PR2, is now interrupted by the second spur gear stage ST2. This means that within the multi-speed transmission 9 there is a ratio modification of the rotational movement between the planetary carriers PT1, PT2 of the planetary gearsets PR1, PR2. Moreover, the drive input shaft 1 and the drive output shaft 2 are now arranged parallel to one another. This also has the consequence that the respective rotational axes of the first planetary gearset PR1 and the second planetary gearset PR2 are arranged parallel to and offset from one another.

FIG. 66 shows a schematic representation of a further arrangement of the fourteenth embodiment of the multi-speed transmission 9 according to the invention. In this case the drive output shaft 2 at the transmission output AB is connected to a first spur gearwheel SR1 of a first spur gear stage ST1. The first spur gearwheel SR1 engages with a second spur gearwheel SR2 of the first spur gear stage ST1, and this second spur gearwheel SR2 is connected to an intermediate shaft ZW. The latter is, further, connected to a first spur gearwheel SR3 of a second spur gear stage ST2. The first spur gearwheel SR3 engages with a second spur gear SR4 of the second spur gear stage ST2, and the second spur gearwheel SR4 is connected to the vehicle axle 10. Thus, rotational movement produced by the drive element 8 can be transmitted to the vehicle axle 10 and the wheels 11 attached thereto, byway of the multi-speed transmission 9 and the spur gear stages ST1, ST2, having regard to their respective transmission ratios.

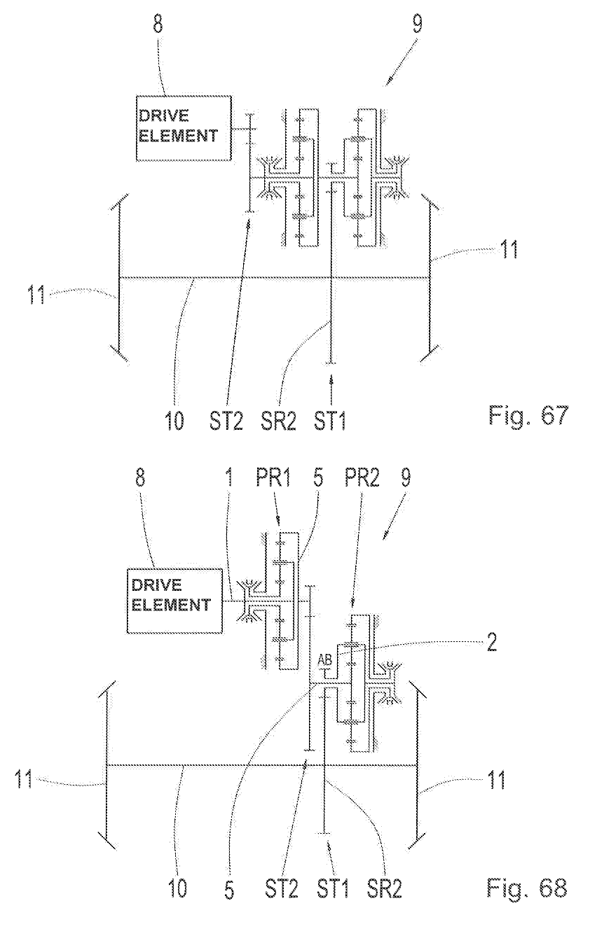

FIG. 67 shows a schematic representation of a further arrangement of the fourteenth embodiment of the multi-speed transmission 9 according to the invention. This arrangement differs from the arrangement shown in FIG. 66, in that the second spur gear stage ST2 is arranged between the drive element 8 and the multi-speed transmission 9. Thus, the rotational movement from the drive element 8 already undergoes a ratio modification before it is introduced into the multi-speed transmission 9. Furthermore there is no intermediate shaft ZW in the arrangement shown here, since the second spur gearwheel SR2 of the first spur gear stage ST1 is connected directly to the vehicle axle 10 instead of to the intermediate shaft ZW (not shown in this case).

FIG. 68 shows a schematic representation of a further arrangement of the fourteenth embodiment of the multi-speed transmission 9 according to the invention. The arrangement shown here differs from the arrangement shown in FIG. 66, in that instead of being connected to an intermediate shaft ZW, the second spur gearwheel SR2 of the first spur gear stage ST1 is connected directly to the vehicle axle 10. Moreover, the second spur gear stage ST2 is arranged between the first planetary gearset PR1 and the second planetary gearset PR2. The fifth shaft 5, which connects the ring gear H1 of the first planetary gearset PR1 to the sun gear S2 of the second planetary gearset PR2, is now interrupted by the second spur gear stage ST2. This also has the result that besides the drive input shaft 1 and the drive output shaft 2, the planetary gearsets PR1, PR2 as well are arranged parallel to and offset from one another in relation to their respective rotational axes. By virtue of the arrangement of the second spur gear stage ST2 shown here, within the multi-speed transmission 9 there is a further ratio modification of the rotational movement introduced from the drive element 8.

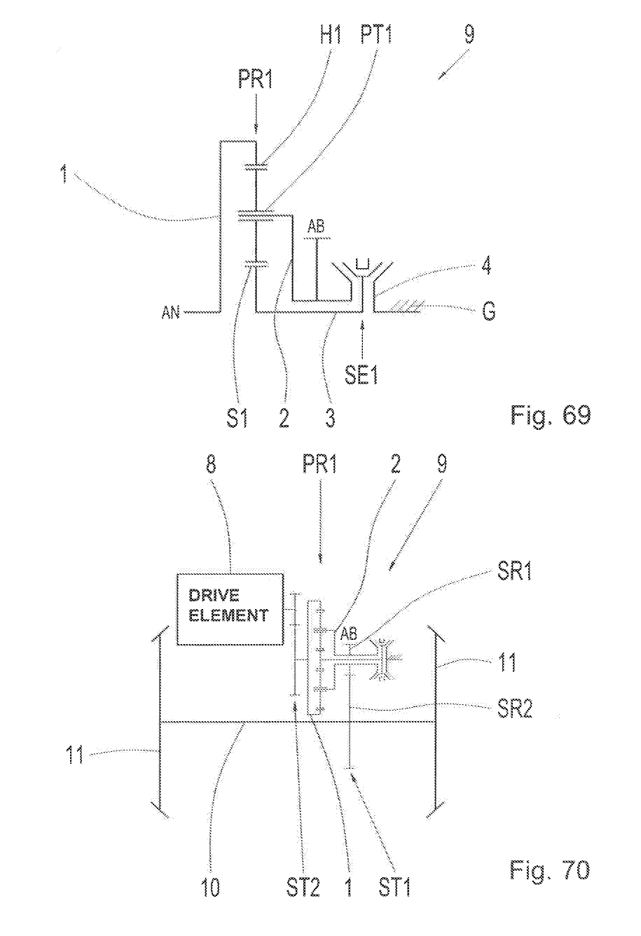

FIG. 69 shows a schematic representation of a fifteenth embodiment of the multi-speed transmission 9 according to the invention. In this case the multi-speed transmission 9 shown comprises a first planetary gearset PR1, a transmission input AN, a transmission output AB and a first shifting element SE1. By way of a drive input shaft 1 a ring gear H1 of the first planetary gearset PR1 is connected to a transmission input AN. By way of a drive output shaft 2 a planetary carrier PT1 of the first planetary gearset PR1 is connected to the transmission output AB and also to a first side of the first shifting element SE1. By way of a third shaft 3 a sun gear S1 of the first planetary gearset PR1 is also connected to the first shifting element SE1. The first shifting element SE1 is, further, connected by a fourth shaft 4 to a housing G.

Starting at the transmission input AN, the transmission input AN, the first planetary gearset PR1, the transmission output AB and the first shifting element SE1 are arranged in the sequence just mentioned. The first planetary gearset PR1, the transmission output AB and the first shifting element SE1 are arranged coaxially with a common rotational axis (not shown here). The first planetary gearset PR1 is designed as a minus planetary gearset.

With this embodiment of the multi-speed transmission 9 a total of two different transmission ratios can be obtained between the transmission input AN and the transmission output AB. The first shifting element SE1 is made as a dual shifting element. By virtue of the first shifting element SE1 the first gear can be obtained when the third shaft 3 is connected to the fourth shaft 4, whereby the third shaft 3 can be braked or fixed relative to the housing G. By virtue of the first shifting element SE1 the second gear can be obtained when the drive output shaft 2 is connected to the third shaft 3.

FIG. 70 shows a schematic representation of a further arrangement of the fifteenth embodiment of the multi-speed transmission 9 according to the invention. At the transmission output AB the drive output shaft 2 is connected to a first spur gearwheel SR1 of a first spur gear stage ST1, this first spur gearwheel SR1 engaging with a second spur gearwheel SR2 of the first spur gear stage ST1 that is connected to a vehicle axle 10. Between a drive element 8 and the multi-speed transmission 9 there is arranged a second spur gear stage ST2 by virtue of which rotational movement produced by the drive element 8 already undergoes a ratio modification before the rotational movement is introduced into the multi-speed transmission 9. The rotational movement introduced by the drive element 8 is transmitted to the vehicle axle and the wheels 11 attached thereto after conversion, having regard to the transmission ratios of the spur gear stages ST1, ST2 and the multi-speed transmission 9.

In a further modification (not shown here) of the above-mentioned embodiment, The drive input shaft AW at the transmission input AN is connected to the drive element 8. At the transmission output AB the rotational movement from the drive element 8 is transmitted to a first spur gear stage ST1, while the second spur gearwheel SR2 of the first spur gear stage ST1 is connected to an intermediate shaft ZW and also to a first spur gearwheel SR3 of a second spur gear stage ST2. The first spur gearwheel SR3 of the second spur gear stage ST2 engages with a second spur gearwheel SR4 of the second spur gear stage ST2 and transmits the rotational movement to the vehicle axle 10 and the wheels 11 attached thereto.

The drive element 8, the multi-speed transmission 9 and each of the spur gear stages ST1, ST2 can be arranged in any position above, below, in front of or behind the vehicle axle 10.

### INDEXES

1 Drive input shaft
2 Drive output shaft
3 Third shaft
4 Fourth shaft
5 Fifth shaft
6 Sixth shaft
7 Seventh shaft
8 Drive element
9 Multi-speed transmission
10 Vehicle axle
11 Wheel
AB Transmission output
AN Transmission input
G Housing
H1 Ring gear of PR1
H2 Ring gear of PR2
PR1 First planetary gearset
PR2 Second planetary gearset
PT1 Planetary carrier of PR1
PT2 Planetary carrier of PR2
S1 Sun gear of PR1
S2 Sun gear of PR2
SE1 First shifting element
SE2 Second shifting element
SR1 First spur gearwheel of ST1
SR2 Second spur gearwheel of ST1
SR3 First spur gearwheel of ST2
SR4 Second spur gearwheel of ST2
SR5 First spur gearwheel of ST3
SR6 Second spur gearwheel of ST3
ST1 First spur gear stage
ST2 Second spur gear stage
ST3 Third spur gear stage
ZW Intermediate shaft

1-18. (canceled)

19. A multi-speed transmission (9) for a rail vehicle, the multi-speed transmission (9) comprising:
at least one transmission input (AN),
at least one transmission output (AB),
at least one planetary gearset (PR1, PR2),
at least one shifting element (SE1, SE2), and
a housing (G);
each of the at least one planetary gearset (PR1, PR2) comprising a sun gear (S1, S2), at least one planetary carrier (PT1, PT2) with planetary gearwheels, and a ring gear (H1, H2);
rotational movement from a drive element (8) being introduced into the multi-speed transmission (9); and
the at least one shifting element (SE1, SE2) being actuatable to obtain at least two different transmission ratios between the transmission input (AN) and the transmission output (AB).

20. The multi-speed transmission for a rail vehicle according to claim 19, wherein the at least one shifting element (SE1, SE2) is a dual shifting element.

21. The multi-speed transmission for a rail vehicle according to claim 19, wherein:
the multi-speed transmission (9) comprises a first planetary gearset (PR1) and a second planetary gearset (PR2), and the rotational movement is introduced into the multi-speed transmission (9) at the transmission input (AN) by a driveshaft (1);
the driveshaft (1) is connected to the sun gear (S1) of the first planetary gearset (PR1);
the planetary carrier (PT1) of the first planetary gearset (PR1) is connected by a third shaft (3) to the ring gear (H2) of the second planetary gearset (PR2);
the ring gear (H1) of the first planetary gearset (PR1) is connected by a fourth shaft (4) to the shifting element (SE1), the shifting element (SE1) is connected by a fifth shaft (5) to the housing (G) and the shifting element (SE1) is connected by a drive output shaft (2) to the planetary carrier (PT2) of the second planetary gearset (PR2) such that by engagement of the shifting element (SE1) either the fifth shaft (5) is connectable to the fourth shaft (4), or the drive output shaft (2) is connectable to the fourth shaft (4);
the sun gear (S2) of the second planetary gearset (PR2) is connected to the housing (G) by a sixth shaft (6); and
by virtue of the multi-speed transmission, two different transmission ratios are implementable between the transmission input (AN) and the transmission output (AB).

22. The multi-speed transmission for a rail vehicle according to claim 19, wherein:
the multi-speed transmission (9) comprises a first planetary gearset (PR1) and a second planetary gearset (PR2), and the rotational movement is introduced into the multi-speed transmission (9) at the transmission input (AN) by a driveshaft (1);
the driveshaft (1) is connected to the sun gear (S1) of the first planetary gearset (PR1);
the transmission output (AB) is connected by a drive output shaft (2) to the planetary carrier (PT1) of the first planetary gearset (PR1), and the planetary carrier (PT2) of the second planetary gearset (PR2) is also connected by the drive output shaft (2) to the ring gear (H2) of the second planetary gearset (PR2);
the ring gear (H1) of the first planetary gearset (PR1) is connected by a third shaft (3) to the shifting element (SE1), the shifting element (SE1) is connected by a fourth shaft (4) to the housing (G), and the shifting element (SE1) is connected by a fifth shaft (5) to the planetary carrier (PT2) of the second planetary gearset (PR2) such that by engagement of the shifting element (SE1) either the fourth shaft (4) is connectable to the third shaft (3) or the third shaft (3) is connectable to the fifth shaft (5);
the sun gear (S2) of the second planetary gearset (PR2) is connected by a sixth shaft (6) to the housing (G); and
by virtue of the multi-speed transmission, two different transmission ratios are implementable between the transmission input (AN) and the transmission output (AB).

23. The multi-speed transmission for a rail vehicle according to claim 19, wherein:
the multi-speed transmission (9) comprises a first planetary gearset (PR1) and a second planetary gearset (PR2), and the rotational movement is introduced into the multi-speed transmission (9) at the transmission input (AN) by a driveshaft (1);
the driveshaft (1) is connected to the sun gear (S1) of the first planetary gearset (PR1) and to the sun gear (S2) of the second planetary gearset (PR2);
the ring gear (H1) of the first planetary gearset (PR1) is connected by a fourth shaft (4) to the housing (G);
the planetary carrier (PT1) of the first planetary gearset (PR1) is connected by a third shaft (3) to the shifting element (SE1), the shifting element (SE1) is connected by a fifth shaft (5) to the ring gear (H2) of the second planetary gearset (PR2), and the shifting element (SE1) is connected by a sixth shaft (6) to the housing (G) such that by engagement of the shifting element (SE1) either the third shaft (3) and the fifth shaft (5) are connectable to one another, or the fifth shaft (5) and the sixth shaft (6) are connectable to one another;
the planetary carrier (PT2) of the second planetary gearset (PR2) is connected by a drive output shaft (2) to the transmission output (AB); and
by virtue of the multi-speed transmission, two different transmission ratios are implementable between the transmission input (AN) and the transmission output (AB).

24. The multi-speed transmission for a rail vehicle according to claim 19, wherein:
the multi-speed transmission (9) comprises a first planetary gearset (PR1) and a second planetary gearset (PR2), and the rotational movement is introduced into the multi-speed transmission (9) at the transmission input (AN) by a driveshaft (1);
the driveshaft (1) is connected to the ring gear (H1) of the first planetary gearset (PR1);
the planetary carrier (PT1) of the first planetary gearset (PR1) is connected by a drive output shaft (2) to the transmission output (AB) and also to the ring gear (H2) of the second planetary gearset (PR2);
the sun gear (S1) of the first planetary gearset (PR1) is connected by a fourth shaft (4) to the shifting element (SE1), the shifting element (SE1) is connected by a fifth shaft (5) to the sun gear (S2) of the second planetary gearset (PR2), and the shifting element (SE1) is connected by a sixth shaft (6) to the housing (G) such that by engagement of the shifting element (SE1) either the fifth shaft (5) is connectable to the fourth shaft (4), or the fourth shaft (4) is connectable to the sixth shaft (6); and
by virtue of the multi-speed transmission, two different transmission ratios are implementable between the transmission input (AN) and the transmission output (AB).

25. The multi-speed transmission for a rail vehicle according to claim 19, wherein:
the multi-speed transmission (9) comprises a first shifting element (SE1) and a second shifting element (SE2), and the rotational movement is introduced into the multi-speed transmission (9) at the transmission input (AN) by a driveshaft (1);
the driveshaft (1) is connected to the first shifting element (SE1) and also to the second shifting element (SE2), the first shifting element (SE1) is connected by a third shaft (3) to the ring gear (H1) of the at least one planetary gearset (PR1), and the first shifting element (SE1) is connected by a fourth shaft (4) to the housing (G) such that by engagement of the first shifting element (SE1) either the driveshaft (1) is connectable to the third shaft (3) or the third shaft (3) is connectable to the fourth shaft (4);
the second shifting element (SE2) is connected by a fifth shaft (5) to the sun gear (S1) of the at least one planetary gearset (PR1) and the second shifting element (SE2) is connected by a sixth shaft (6) to the housing (G) such that by engagement of the second shifting element (SE2) either the fifth shaft (5) is connectable to the driveshaft (1) or the fifth shaft (5) is connectable to the sixth shaft (6);
the planetary carrier (PT1) of the at least one planetary gearset (PR1) is connected by a drive output shaft (2) to the transmission output (AB); and
by virtue of the arrangement, three different transmission ratios are implementable between the transmission input (AN) and the transmission output (AB).

26. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft (1) is connected to the first shifting element (SE1) and also to the planetary carrier (PT1) of the first planetary gearset (PR1);
the first shifting element (SE1) is connected by a third shaft (3) to the sun gear (S1) of the first planetary gearset (PR1) and the ring gear (H2) of the second planetary gearset (PR2), and the first shifting element (SE1) is connected by a fourth shaft (4) to the housing (G) such that by engagement of the first shifting element (SE1) either the driveshaft (1) is connectable to the third shaft (3) or the third shaft (3) is connectable to the fourth shaft (4);
the ring gear (H1) of the first planetary gearset (PR1) is connected by a fifth shaft (5) to the sun gear (S2) of the second planetary gearset (PR2) and also to the second shifting element (SE2) and the second shifting element (SE2) is connected by a sixth shaft (6) to the housing (G) such that the fifth shaft (5) is connectable by engagement of the second shifting element (SE2) to the sixth shaft (6);
the planetary carrier (PT2) of the second planetary gearset (PR2) is connected by a drive output shaft (2) to the transmission output (AB);
by virtue of the multi-speed transmission, three different transmission ratios are implementable between the transmission input (AN) and the transmission output (AB).

27. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft (1) is connected to the first shifting element (SE1) and also to the sun gear (S1) of the first planetary gearset (PR1);
the first shifting element (SE1) is connected by a third shaft (3) to the ring gear (H1) of the first planetary gearset (PR1) and also to the second shifting element (SE2), and the first shifting element (SE1) is connected by a fourth shaft (4) to the housing (G) such that by engagement of the first shifting element (SE1) either the driveshaft (1) is connectable to the third shaft (3) or the third shaft (3) is connectable to the fourth shaft (4);
the planetary carrier (PT1) of the first planetary gearset (PR1) is connected by a drive output shaft (2) to the ring gear (H2) of the second planetary gearset (PR2) and also to the transmission output (AB);
the second shifting element (SE2) is connected by a fifth shaft (5) to the planetary carrier (PT2) of the second planetary gearset (PR2) such that by engagement of the second shifting element (SE2) the third shaft (3) is connectable to the fifth shaft (5);
the sun gear (S2) of the second planetary gearset (PR2) is connected by a sixth shaft (6) to the housing (G); and
by virtue of the multi-speed transmission, three different transmission ratios are implementable between the transmission input (AN) and the transmission output (AB).

28. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft (1) is connected to the sun gear (S1) of the first planetary gearset (PR1), the sun gear (S2) of the second planetary gearset (PR2) and the second shifting element (SE2);
the planetary carrier (PT1) of the first planetary gearset (PR1) is connected by a drive output shaft (2) to the transmission output (AB);
the ring gear (H1) of the first planetary gearset (PR1) is connected by a third shaft (3) to the first shifting element (SE1) and also to the planetary carrier (PT2) of the second planetary gearset (PR2), and the first shifting element (SE1) is connected by a fourth shaft (4) to the housing (G) such that the third shaft (3) is connectable by engagement of the first shifting element (SE1) to the fourth shaft (4);
the ring gear (H2) of the second planetary gearset (PR2) is connected by a fifth shaft (5) to the second shifting element (SE2) and the second shifting element (SE2) is connected by a sixth shaft (6) to the housing (G) such that by engagement of the second shifting element (SE2) either the fifth shaft (5) is connectable to the sixth shaft (6) or the fifth shaft (5) is connectable to the driveshaft (1); and
by virtue of the multi-speed transmission, three different transmission ratios are implementable between the transmission input (AN) and the transmission output (AB).

29. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft is connected to the first shifting element (SE1), the sun gear (S1) of the first planetary gearset (PR1), and the sun gear (S2) of the second planetary gearset (PR2);
the first shifting element (SE1) is connected by a drive output shaft (2) to the transmission output (AB) and also to the planetary carrier (PT1) of the first planetary gearset (PR1) such that by engagement of the first shifting element (SE1) the driveshaft (1) is connectable to the drive output shaft (2);
the ring gear (H1) of the first planetary gearset (PR1) is connected by a third shaft (3) to the second shifting element (SE2) and the second shifting element (SE2) is connected by a fourth shaft (4) to the housing (G) and by a fifth shaft (5) to the planetary carrier (PT2) of the second planetary gearset (PR2) such that by engagement of the second shifting element (SE2) either the fourth shaft (4) is connectable to the third shaft (3) or the third shaft (3) is connectable to the fifth shaft (5);
the ring gear (H2) of the second planetary gearset (PR2) is connected by a sixth shaft (6) to the housing (G); and
by virtue of the multi-speed transmission, three different transmission ratios are implementable between the transmission input (AN) and the transmission output (AB).

30. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft (1) is connected to the first shifting element (SE1) and also to the sun gear (S1) of the first planetary gearset (PR1);
the first shifting element (SE1) is connected by a fourth shaft (4) to the housing (G) and by a third shaft (3) to the ring gear (H1) of the first planetary gearset (PR1) and also to the planetary carrier (PT2) of the second planetary gearset (PR2), such that by engagement of the first shifting element (SE1) either the driveshaft (1) is connectable to the third shaft (3) or the third shaft (3) is connectable to the fourth shaft (4);
the ring gear (H2) of the second planetary gearset (PR2) is connected by a drive output shaft (2) to the planetary carrier (PT1) of the first planetary gearset (PR1) and also to the transmission output (AB);
the sun gear (S2) of the second planetary gearset (PR2) is connected by a fifth shaft (5) to the second shifting element (SE2) and the second shifting element (SE2) is connected by a sixth shaft (6) to the housing (G) such that by engagement of the second shifting element (SE2) the fifth shaft (5) is connectable to the sixth shaft (6); and
by virtue of the multi-speed transmission, three different transmission ratios are implementable between the transmission input (AN) and the transmission output (AB).

31. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft (1) is connected to the first shifting element (SE1) and also to the sun gear (S1) of the first planetary gearset (PR1);
the first shifting element (SE1) is connected by a fourth shaft (4) to the housing (G) and the first shifting element (SE1) is connected by a third shaft (3) to the ring gear (H1) of the first planetary gearset (PR1) and also to the second shifting element (SE2) such that by engagement of the first shifting element (SE1) either the driveshaft (1) is connectable to the third shaft (3) or the third shaft (3) is connectable to the fourth shaft (4);
the planetary carrier (PT1) of the first planetary gearset (PR1) is connected by a fifth shaft (5) to the ring gear (H2) of the second planetary gearset (PR2);
the planetary carrier (PT2) of the second planetary gearset (PR2) is connected by a drive output shaft (2) to the second shifting element (SE2) and also to the transmission output (AB) such that by engagement of the second shifting element (SE2) the drive output shaft (2) is connectable to the third shaft (3);
the sun gear (S2) of the second planetary gearset (PR2) is connected by a sixth shaft (6) to the housing (G); and
by virtue of the multi-speed transmission, three different transmission ratios are implementable between the transmission input (AN) and the transmission output (AB).

32. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft (1) is connected to the first shifting element (SE1) and to the sun gear (S1) of the first planetary gearset (PR1);
the first shifting element (SE1) is connected by a third shaft (3) to the ring gear (H1) of the first planetary gearset (PR1) and by a fourth shaft (4) to the housing (G) such that by engagement of the first shifting element (SE1) either the driveshaft (1) is connectable to the third shaft (3) or the third shaft (3) is connectable to the fourth shaft (4);
the planetary carrier (PT1) of the first planetary gearset (PR1) is connected by a fifth shaft (5) to the ring gear (H2) of the second planetary gearset (PR2);
the planetary carrier (PT2) of the second planetary gearset (PR2) is connected by a drive output shaft (2) to the second shifting element (SE2) and also to the transmission output (AB);
the sun gear (S2) of the second planetary gearset (PR2) is connected by a sixth shaft (6) to the second shifting element (SE2) and the second shifting element (SE2) is connected by a seventh shaft (7) to the housing (G) such that by engagement of the second shifting element (SE2) either the sixth shaft (6) is connectable to the seventh shaft (7) or the sixth shaft (6) is connectable to the drive output shaft (2); and
by virtue of the multi-speed transmission, four different transmission ratios are implementable between the transmission input (AN) and the transmission output (AB).

33. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft (1) is connected to the first shifting element (SE1) and the sun gear (S1) of the first planetary gearset (PR1);
the first shifting element (SE1) is connected by a third shaft (3) to the ring gear (H1) of the first planetary gearset (PR1) and by a fourth shaft (4) to the housing (G) such that by engagement of the first shifting element (SE1) either the driveshaft (1) is connectable to the third shaft (3) or the third shaft (3) is connectable to the fourth shaft (4);
the planetary carrier (PT1) of the first planetary gearset (PR1) is connected by a fifth shaft (5) to the planetary carrier (PT2) of the second planetary gearset (PR2);
the ring gear (H2) of the second planetary gearset (PR2) is connected by a drive output shaft (2) to the transmission output (AB) and also to the second shifting element (SE2);
the second shifting element (SE2) is connected by a sixth shaft (6) to the sun gear (S2) of the second planetary gearset (PR2) and by a seventh shaft (7) to the housing (G) such that by engagement of the second shifting element (SE2) either the drive output shaft (2) is connectable to the sixth shaft (6) or the sixth shaft (6) is connectable to the seventh shaft (7); and
by virtue of the multi-speed transmission, four different transmission ratios are implementable between the transmission input (AN) and the transmission output (AB).

34. The multi-speed transmission for a rail vehicle according to claim 19, wherein:
the multi-speed transmission (9) comprises a first planetary gearset (PR1), a second planetary gearset (PR2), a first shifting element (SE1) and a second shifting element (SE2), and the rotational movement is introduced into the multi-speed transmission (9) at the transmission input (AN) by a driveshaft (1);
the driveshaft (1) is connected to the first shifting element (SE1) and the planetary carrier (PT1) of the first planetary gearset (PR1);
the first shifting element (SE1) is connected by a third shaft (3) to the sun gear (S1) of the first planetary gearset (PR1) and by a fourth shaft (4) to the housing (G) such that by engagement of the first shifting element (SE1) either the driveshaft (1) is connectable to the third shaft (3) or the third shaft (3) is connectable to the fourth shaft (4);
the ring gear (H1) of the first planetary gearset (PR1) is connected by a fifth shaft (5) to the sun gear (S2) of the second planetary gearset (PR2);
the transmission output (AB) is connected by a drive output shaft (2) to the planetary carrier (PT2) of the second planetary gearset (PR2) and also to the second shifting element (SE2);
the second shifting element (SE2) is connected by a sixth shaft (6) to the ring gear (H2) of the second planetary gearset (PR2) and by a seventh shaft (7) to the housing (G) such that by engagement of the second shifting element (SE2) either the seventh shaft (7) is connectable to the sixth shaft (6) or the sixth shaft (6) is connectable to the drive output shaft (2); and
by virtue of the multi-speed transmission, four different transmission ratios are implementable between the transmission input (AN) and the transmission output (AB).

35. The multi-speed transmission for a rail vehicle according to claim 19, wherein:
the multi-speed transmission (9) comprises a first planetary gearset (PR1) and the shifting element (SE1), and the rotational movement is introduced into the multi-speed transmission (9) at the transmission input (AN) by a driveshaft (1);
the driveshaft (1) is connected to the ring gear (H1) of the first planetary gearset (PR1);
the planetary carrier (PT1) of the first planetary gearset (PR1) is connected by a drive output shaft (2) to the transmission output (AB) and also to the shifting element (SE1);
the shifting element (SE1) is connected by a third shaft (3) to the sun gear (S1) of the first planetary gearset (PR1) and by a fourth shaft (4) to the housing (G) such that by engagement of the shifting element (SE1) either the drive output shaft (2) is connectable to the third shaft (3) or the third shaft (3) is connectable to the fourth shaft (4); and
by virtue of the multi-speed transmission, two different transmission ratios are implementable between the transmission input (AN) and the transmission output (AB).

36. The multi-speed transmission for a rail vehicle, according to claim 19, wherein a gear interval φ between two adjacent transmission ratios has a value 1.6≦φ≦2 such that an adaptation of an overall transmission ratio of the multi-speed transmission takes place by virtue of at least one transmission stage connected at least one of upstream and downstream from the multi-speed transmission.
